(19) United States
(12) Patent Application Publication
(10) Pub. No.: US 2026/0003842 A1
(43) Pub. Date: Jan. 1, 2026

(54) DEVICE FOR TRANSFORMING A STRUCTURED DATA ARRAY CONTAINING INFORMATION OBJECTS OF A DIGITALIZED DOCUMENT

(71) Applicant: IGOR PETROVICH ROGACHEV, Moscow (RU)

(72) Inventor: IGOR PETROVICH ROGACHEV, Moscow (RU)

(21) Appl. No.: 18/885,080

(22) Filed: Sep. 13, 2024

(30) Foreign Application Priority Data
Jun. 29, 2024 (RU) 2024118088

(51) Int. Cl. G06F 16/22; G06V 30/414; G06V 30/416

(52) U.S. Cl. CPC G06F 16/2228; G06V 30/414; G06V 30/416

(57) ABSTRACT

The group of inventions relates to solutions in the field of processing data arrays, in particular, to solutions in the field of processing digitized documents containing information objects such as text and/or images, and can be used to transform a digitized document for efficient indexing of its elements and accurate search. The technical problem solved by the claimed invention is the creation of inventions that do not have the disadvantages of the closest analogue and thus have increased efficiency in processing digitized documents for subsequent indexing of its elements, their processing and conducting searches using them. Another technical problem solved by the claimed invention is the expansion of the arsenal of technical means-methods for converting structured data arrays containing information objects of digitized documents. The technical result achieved by implementing the claimed invention, in addition to realizing its purpose, is the elimination of the disadvantages of the closest analogue and thus an increase in the efficiency of processing digitized documents for subsequent indexing of its elements, their processing and conducting searches using them.

### FIELD OF INVENTION

The group of inventions relates to the field of data array processing, particularly to processing of digitalized documents that contain information objects, such as text and/or images, and can be used for transforming digitalized documents in order to effectively index elements thereof and enable accurate search therein.

### DESCRIPTION OF THE RELATED ART

Russian patent 2544739 (ROGACHEV Igor Petrovich, published on Mar. 20, 2015 (D1) discloses a method for transforming a structured data array. The method known from D1 involves the following steps: generating (101) the first data structure of the structured data array from the final data structure of the structured data array; generating (102) a database of logical connections between logical sections of the elements of the first data structure; generating (103) the second data structure of the structured data array; generating (104) a database of meaning components of logical sections of the elements of the second data structure; through linguistic transformations of said meaning components, generating (105) grammatically and orthographically correct meaning components of logical sections of the elements of the second data structure; and generating (106) the final data structure of the structured data array;

The method of D1 provides convertation of a structured data array in order to obtain logical structures containing grammatically and orthographically correct meaning components, which can be useful to enhance the accuracy of information search in non-specialized data arrays, such as, for example, fiction or non-fiction texts. At the same time, transformations according to D1 do not generate basic constructs of subject area, much less target constructs of subject area, which are necessary for reliable identification of subject roles, required for high-accuracy search in specialized subject areas, such as, for example, the legal domain. In addition, the method of D1 is suitable only for texts in natural language, i.e., it requires that the texts be selected from the document in advance.

The solution disclosed in D1 can be considered the closest prior art to the claimed invention.

### SUMMARY OF THE INVENTION

The technical problem to be solved by the proposed invention is to create an invention that does not possess the drawbacks of the prior art and thus has an enhanced efficiency in processing digitalized documents for further indexation and processing of their elements, and using them to conduct searches. Another technical problem to be solved by the proposed invention is to expand the technical means, i.e., methods for transforming structured data arrays containing information objects of digitalized documents.

The objective of the proposed invention, in addition to it performing its functions, is to eliminate the drawbacks of the prior art and thus to enhance the efficiency of processing digitalized documents for further indexation and processing of their elements, and using them to conduct searches.

The objective of the present invention is achieved by a computer device for transforming a structured data array, the array comprising at least information objects in a digitalized document, which are separate blocks of information content of the digitalized document, represented by text information objects, and/or visual information objects, and/or text-visual information objects; the device comprising at least: a CPU; a memory which contains a program code, which, when executed by at least one CPU of a computer device induces the computer device to perform a method for transforming a structured data array, the array comprising at least information objects in a digitalized document, which are separate blocks of information content of the digitalized document, represented by text information objects, and/or visual information objects, and/or text-visual information objects; the method comprising: generating at step 1001 a first data structure comprising meaning components of the information objects in the digitalized document, as well as comprising identification data of said meaning components, which comprises meanings of the meaning components and their index numbers in the digitalized document; generating at step 1002 a database of system features of the meaning components by identifying system features in the first data structure of meaning components, namely their formatting system characteristics and functional system characteristics, as well as meanings of corresponding system characteristics, in order to identify meaning components with structural system features, and/or meaning components with logical system features, and/or meaning components with information system features, and/or meaning components with meta system features, and generating the database from the identified system features; generating at step 1003 a second data structure comprising integrated meaning components of information objects in the digitalized document, which are either grouped meaning components from the first data structure with matching system features or grouped meaning components from the first data structure with unique system features, as well as comprising identification data of said integrated meaning components, represented by non-repeating varieties of said meaning components with either matching system features or unique system features, and meanings of said meaning components with either matching system features or unique system features, and their index numbers in the digitalized document, wherein such meaning components with either matching system features or unique system features form said integrated meaning components; generating at step 1004 a third data structure comprising linguistic constructs, which are said integrated meaning components of information objects in the digitalized document contained in the second data structure, wherein said integrated meaning components have system features of text-logical meaning components, as well as comprising identification data of said linguistic constructs, which comprises meanings of said linguistic constructs and their index numbers in the digitalized document, wherein said linguistic constructs in the digitalized document can be represented by: either regular linguistic constructs from the third data structure, which are language sentences, or special linguistic constructs from the third data structure, which are lists or rolls, or reconstructible linguistic constructs from the third data structure, which are tables comprised of at least two rows and two columns, wherein at least one row contains column headings and/or at least one column contains row headings respectively, or a combination thereof; generating at step 1005 a fourth data structure comprising language sentences generated from elements of the third data structure and represented by: either regular linguistic constructs from the third data structure, or language sentences obtained by transforming special linguistic constructs from the third data structure, or language sentences recreated from reconstructible linguistic constructs from the third data structure, wherein the fourth data structure as well as comprises identification data of said language sentences, which comprises meanings of said language sentences and their index numbers in the fourth data structure; generating at step 1006 a fifth data structure comprising text elements of said language sentences from the fourth data structure, as well as comprising identification data of said text elements, which comprises meanings of said text elements and their index numbers in corresponding language sentences from the fourth data structure; generating at step 1007 a database of linguistic-logical-subject features by identifying linguistic-logical-subject features of said text elements of said language sentences from the fourth data structure, and generating a database from said identified features; generating at step 1008 a sixth data structure comprising simple judgement components, which are contained in corresponding language sentences from the fourth data structure, as well as comprising identification data of said simple judgement components, which comprises a type of a component, its meaning, and its index number in corresponding language sentence; generating at step 1009 a seventh data structure comprising simple judgements from corresponding language sentences from the fourth data structure, as well as comprising identification data of said simple judgements, which comprises meanings of said simple judgements and their index numbers in corresponding language sentences from the fourth data structure; generating at step 1010 an eighth data structure comprising resulting judgements from corresponding language sentences from the fourth data structure which are generated from said simple judgements from corresponding language sentences from the fourth data structure, as well as comprising identification data of said resulting judgements, which comprises meanings of said resulting judgements and their index numbers in the eighth data structure; generating at step 1011 a ninth data structure comprising basic constructs of subject area which are generated from data that include the data from the sixth data structure generated in step 1008, wherein said basic constructs of subject area are generated based on data of a formalized model of the basic construct of subject area and data of a formalized model of the logical construct of a judgement, as well as comprising identification data of said basic constructs of subject area, which comprises meanings of said basic constructs and their index numbers in the ninth data structure; and generating at step 1012 a final data structure comprising target constructs of subject area which are generated from said basic constructs of subject area contained in the ninth data structure, wherein said target constructs are generated based on the data of a formalized model of the target construct of subject area, as well as comprising identification data of said target constructs of subject area, which comprises meanings of the target constructs and their index numbers in the final data structure.

### BRIEF DESCRIPTION OF THE DRAWINGS

Exemplary embodiments of the present invention are described in further detail below with references made to the attached drawings, included herein by reference:

FIG. 1 illustrates an exemplary, non-limiting, overall scheme for the steps of the method 1000.

FIG. 2 illustrates an exemplary, non-limiting, overall scheme for the steps in step 1001.

FIG. 3 illustrates an exemplary, non-limiting, general diagram of the initial data structure.

FIG. 4 illustrates an exemplary, non-limiting, general diagram of a generated first data structure.

FIG. 5 illustrates an exemplary, non-limiting, overall scheme for the steps in step 1002.

FIG. 6 illustrates an exemplary, non-limiting, general diagram of a generated database of system features.

FIG. 7 illustrates an exemplary, non-limiting, overall scheme for the steps in step 1003.

FIG. 8 illustrates an exemplary, non-limiting, general diagram of a generated second data structure.

FIG. 9 illustrates an exemplary, non-limiting, overall scheme for the steps in step 1004.

FIG. 10 illustrates an exemplary, non-limiting, general diagram of a generated third data structure.

FIG. 11 illustrates an exemplary, non-limiting, overall scheme for the steps in step 1005.

FIG. 12 illustrates an exemplary, non-limiting, general diagram of a generated fourth data structure.

FIG. 13 illustrates an exemplary, non-limiting, overall scheme for the steps in step 1006.

FIG. 14 illustrates an exemplary, non-limiting, general diagram of a generated fifth data structure.

FIG. 15 illustrates an exemplary, non-limiting, overall scheme for the steps in step 1007.

FIG. 16 illustrates an exemplary, non-limiting, general diagram of a generated database of linguistic-logical-subject features.

FIG. 17 illustrates an exemplary, non-limiting, overall scheme for the steps in step 1008.

FIG. 18 illustrates an exemplary, non-limiting, general diagram of a generated sixth data structure.

FIG. 19 illustrates an exemplary, non-limiting, overall scheme for the steps in step 1009.

FIG. 20 illustrates an exemplary, non-limiting, general diagram of a generated seventh data structure.

FIG. 21 illustrates an exemplary, non-limiting, overall scheme for the steps in step 1010.

FIG. 22 illustrates an exemplary, non-limiting, general diagram of a generated eighth data structure.

FIG. 23 illustrates an exemplary, non-limiting, overall scheme for the steps in step 1011.

FIG. 24 illustrates an exemplary, non-limiting, general diagram of a generated ninth data structure.

FIG. 25 illustrates an exemplary, non-limiting, overall scheme for the steps in step 1012.

FIG. 26 illustrates an exemplary, non-limiting, general diagram of a generated final data structure.

FIG. 27 illustrates an exemplary, non-limiting, overall scheme for the system 2000.

### DETAILED DESCRIPTION OF THE PREFERRED EMBODIMENTS

The present disclosure demonstrates only certain exemplary embodiments of the proposed invention, which by no means limit its scope. The proposed invention may be embodied in alternative forms that do not go beyond the scope of the present disclosure and may be obvious to persons having ordinary skill in the art.

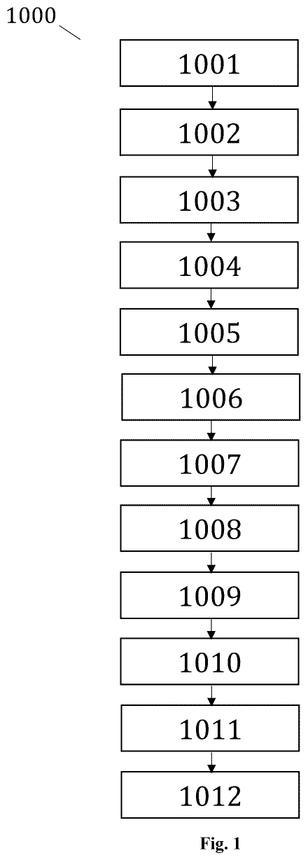

FIG. 1 illustrates an exemplary, non-limiting, overall scheme for the steps of the method 1000 for transforming a structured data array, performed by one or multiple CPUs of a computer device, the array comprising at least information objects in the digitalized document, which are separate blocks of the information content of the digitalized document, represented by text information objects, and/or visual information objects, and/or text-visual information objects; the method comprising generating 1001 a first data structure comprising the meaning components of the information objects in the digitalized document, as well as comprising identification data of said meaning components, which comprises meanings of the meaning components and their index numbers in the digitalized document; generating 1002 a database of system features of the meaning components by identifying the system features in the first data structure of meaning components, namely their formatting system characteristics and functional system characteristics, as well as meanings of corresponding said system characteristics, in order to identify meaning components with structural system features, and/or meaning components with logical system features, and/or meaning components with information system features, and/or meaning components with requisite system features, and generating a database from the identified system features; generating 1003 a second data structure comprising integrated meaning components of information objects in the digitalized document, either grouped meaning components from the first data structure with matching system features or grouped meaning components from the first data structure with unique system features, as well as comprising identification data of said integrated meaning components, represented by non-repeating varieties of said meaning components with either matching system features or unique system features, meanings of said meaning components with either matching system features or unique system features, and their index numbers in the digitalized document, wherein such meaning components with either matching system features or unique system features form said integrated meaning components; generating 1004 a third data structure comprising linguistic constructs, which are said integrated meaning components of information objects in the digitalized document contained in the second data structure, wherein said integrated meaning components have system features of text-logical meaning components, as well as comprising identification data of said linguistic constructs, which comprises meanings of the linguistic constructs and their index numbers in the digitalized document, wherein the linguistic constructs in the digitalized document can be represented by either regular linguistic constructs from the third data structure, which are language sentences, or special linguistic constructs from the third data structure, which are lists or rolls, or reconstructible linguistic constructs from the third data structure, which are tables comprised of at least two rows and two columns, wherein at least one row contains column headings and/or at least one column contains row headings respectively, or a combination thereof; generating 1005 a fourth data structure comprising language sentences generated from the elements of the third data structure and represented by either regular linguistic constructs from the third data structure, or language sentences obtained by transforming special linguistic constructs from the third data structure, or language sentences recreated from reconstructible linguistic constructs from the third data structure, as well as comprising identification data of said language sentences, which comprises meanings of said language sentences and their index numbers in the fourth data structure; generating 1006 a fifth data structure comprising text elements of said language sentences from the fourth data structure, as well as comprising identification data of said text elements, which comprises meanings of said text elements and their index numbers in corresponding language sentences from the fourth data structure; generating 1007 a database of linguistic-logical-subject features by identifying linguistic-logical-subject features of said text elements of said language sentences from the fourth data structure, and generating a database from said identified features; generating 1008 a sixth data structure comprising simple judgement components of corresponding simple judgements, which are contained in corresponding language sentences from the fourth data structure, as well as comprising identification data of said simple judgement components, which comprises the type of a component, its meaning, and its index number in corresponding language sentence; generating 1009 a seventh data structure comprising simple judgements from corresponding language sentences from the fourth data structure, as well as comprising identification data of said simple judgements, which comprises meanings of the simple judgements and their index numbers in corresponding language sentences from the fourth data structure; generating 1010 an eighth data structure comprising resulting judgements from corresponding language sentences from the fourth data structure which are generated from the aforementioned simple judgements from corresponding language sentences from the fourth data structure, as well as comprising identification data of said resulting judgements, which comprises meanings of said resulting judgements and their index numbers in the eighth data structure; generating 1011 a ninth data structure comprising basic constructs of subject area which are generated from the data that include the data from the sixth data structure generated in step 1008, wherein said basic constructs of subject area are generated based on the data of a formalized model of the basic construct of subject area and the data of a formalized model of the logical construct of a judgement, as well as comprising identification data of said basic constructs of subject area, which comprises meanings of said basic constructs and their index numbers in the ninth data structure; and generating 1012 a final data structure comprising target constructs of subject area which are generated from said basic constructs of subject area contained in the ninth data structure, wherein said target constructs are generated based on the data of a formalized model of the target construct of subject area, as well as comprising identification data of said target constructs of subject area, which comprises meanings of the target constructs and their index numbers in the final data structure.

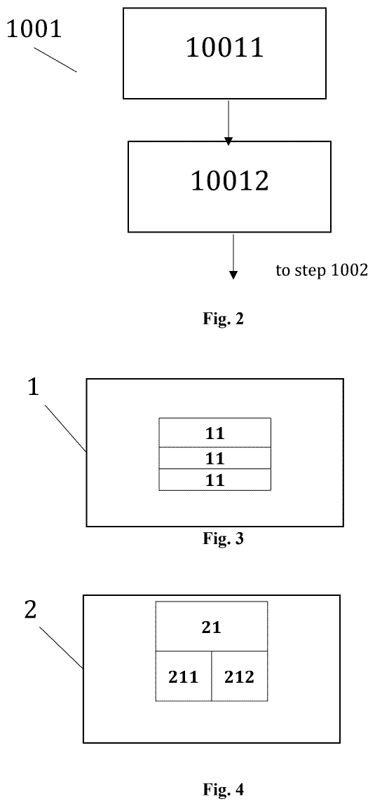

FIG. 2 illustrates an exemplary, non-limiting, overall scheme for the steps in step 1001 of generating the first data structure 2. Step 1001 involves identifying 10011 the elements 11 of the initial data structure 1, represented by information objects 11 in the digitalized document 1; and identifying 10012 the elements 21 of the first data structure 2, represented by meaning components 21 of information objects 11 in the digitalized document 1, as well as comprising identification data of said elements 21, which comprises the meaning 211 of each of the meaning components 21 and their index numbers 212 in the digitalized document 1, and generating the first data structure 2 from them.

FIG. 3 illustrates an exemplary, non-limiting, general diagram of the initial data structure 1 (of the initial structured data array [SDA] 1—the digitalized document 1), from which the elements of the first data structure of the SDA are generated. Preferably, but not limited to, the data source for generating the initial SDA 1 is, for example, but not limited to, a digitalized (electronic) document, i.e., a document that has been converted from its inherent traditional form into an electronic data file, which can be recorded onto electronic media. Preferably, but not limited to, a digitalized (electronic) document is a systematically organized combination of individual information content blocks, i.e., information objects. Preferably, but not limited to, each individual information object is complete, both semantically and logically. Said information content blocks are designed for various purposes, for example, but not limited to, to provide information through text, and/or to provide information through visual images, and/or to provide information through text and visual images.

Preferably, but not limited to, the initial data structure that characterizes the initial SDA 1, contains elements 11, which include at least information objects 11 in the initial SDA 1 (the digitalized document 1). Preferably, but not limited to, information objects 11 consist of any number of information object components, such as, for example, but not limited to, individual string objects, and/or list objects, and/or table objects, and/or visual objects. In addition, for example, but not limited to, said components are first generated from the information objects 11 using various technical means and methods, for example, but not limited to, linguistic tools (for example, but not limited to, several sentences are combined into a paragraph using technical means known from prior art or any other suitable means, which are not described any further), or, but not limited to, technical means known from prior art or any other suitable means available in various electronic text editors (for example, but not limited to, information in the document is separated through tabulations, line breaks, or other similar actions), wherein, but not limited to, said information object 11 components can be also, but not limited to, generated using automatic means known from prior art, as well as, but not limited to, machine learning or neural network technologies. Preferably, but not limited to, information object components serve as technical means for providing information of certain types. For example, but not limited to, information object components may differ according to the type of information provided. For example, but not limited to, in order to provide information through text, text-type information object components are used, such as, for example, but not limited to, string objects, and/or list objects, and/or table objects, and so on. For example, but not limited to, in order to provide information through visual images, image-type information object components are used, such as, for example, but not limited to, logos, drawings, handwritten text, photographs, and so on. For example, but not limited to, in order to provide information through text and visual images, text-visual type information object components are used, that, for example, but not limited to, combine the text-type and visual-type information object components mentioned above. Preferably, but not limited to, elements 11 in the initial data structure 1 can be referred to, for example, but not limited to, as IO1, IO2, IO3, and IOn, where n≥1 is the index number of the element 11 in the digitalized document. Preferably, but not limited to, all the aforementioned information objects 11 in the digitalized document 1 of the initial data structure are individual information objects 11, prepared in advance and put into the initial data structure 1 as a structured array of individual information objects 11 in the digitalized document 1. In addition, preferably, but not limited to, these preparations can be carried out in any way known from prior art and, accordingly, are not described any further. Preferably, but not limited to, the elements 11 of the initial data structure are identified in step 10011 by looking out for features of an information object in the digitalized document. Such features may include, for example, but not limited to, a grouping of a number of successive information object components in the digitalized document 1, the grouping represented by, but not limited to, control symbols (tags, control commands), such as line breaks (EOL, newline), and/or tabulation. As a rule, all successive information objects 11 are separated by such control symbols on both sides. In addition, for example, but not limited to, there will be no such feature in front of the first information object 11 in the digitalized document 1, and there will be no such feature after the last information object 11 in the digitalized document 1 as well. The elements 11 identified by these methods form the initial data structure of SDA 1. Preferably, but not limited to, these preparations can be carried out in any way known from prior art and, accordingly, are not described any further. In addition, preferably, but not limited to, the initial SDA 1 is the array of information objects in the digitalized (electronic) document, comprising the elements 11 of the digitalized document 1 that have been identified in step 1011.

FIG. 4 illustrates an exemplary, non-limiting, general diagram of a generated first data structure 2 of the SDA. Preferably, but not limited to, the first data structure contains the elements 21, represented by meaning components (SC) 21 of the information objects 11 in the digitalized document 1, as well as their identification data, which include meanings 211 of meaning components 21 and their index numbers 212. For example, but not limited to, each meaning component 21 of the information object 11 in the digitalized document 1 is an individual information object 11 or a part thereof with homogeneous information object components (IOCs). For example, but not limited to, the IOCs of an information object 11 can be considered homogeneous in case they belong to the same kind of data, for example, but not limited to, stringed text data, or listed text data, or tabular text data, or visual data. For example, but not limited to, the meaning 211 of a meaning component 21 can be a letter sequence, and/or a word sequence, and/or a digit sequence, and/or a number sequence, and/or punctuation mark sequence, and/or a sequence of other symbols, and/or a table, as well as, for example, but not limited to, a logo, and/or an image, and/or a drawing, and/or handwritten text, and/or a photograph, etc., comprising the meaning component 21. For example, but not limited to, the index number 212 of the meaning component 21 of an information object 11 is its index number in the digitalized document 1. For example, but not limited to, in the first data structure, the elements 21 can be referred to as SC1, SC2, SC3, and SCn, where n≥1 is the index number of the element 21 in the digitalized document. Preferably, but not limited to, the elements 21 of the first data structure are identified in step 10012 by analyzing the information object components (IOCs) for each of the information objects 11 in the digitalized document 1. Preferably, but not limited to, the analysis is focused on checking whether the IOCs of each of the information objects 11 are homogeneous. In case all the IOCs of an individual information object 11 belong to the same kind of data, then that information object 11 is used to form an individual meaning component 21. In case the IOCs of an individual information object 11 belong to different kinds of data, then that information object 11 is split into fragments. In addition, each of the fragments of the split information object 11 is then used, but not limited to, to form an individual split meaning component 21, except in the case where successive text IOCs of any kind contain visual IOCs. In this case, such visual IOCs are used to form a nested visual meaning component 21, while the fragments of the text IOCs, divided by the visual IOCs, are used together to form a combined meaning component 21. In addition, but not limited to, the nested visual meaning component 21 that was removed from the combined meaning component 21 is replaced with a replacement text (for example, but not limited to, if the nested visual meaning component 21 was an image, then the replacement text will be “IMAGE”) and inserted into the combined meaning component 21 at the same location from which the nested visual meaning component 21 was removed, so as to restore the sequence of the text IOCs in the information object 11, from which the combined meaning component 21 is formed. Preferably, but not limited to, the meaning 211 of a meaning component 21 is identified in step 10012 by registering the contents of the IOCs (a letter sequence, and/or a word sequence, and/or a digit sequence, and/or a number sequence, and/or punctuation mark sequence, and/or a sequence of other symbols, and/or a table, and/or a logo, and/or an image, and/or a drawing, and/or handwritten text, and/or a photograph, etc.), which comprises the meaning component 21. Preferably, but not limited to, the index number 212 of a meaning component 21 from the first data structure is identified in step 10012 by calculating the locations of the IOCs comprising the meaning component 21 in the digitalized document 1. In addition, since, but not limited to, the number of elements 21 can significantly exceed the number of elements 11, then the sequential numbering of the elements 11 is performed, for example, but not limited to, by using the following procedure consisting of two steps. In the first step, a preliminary number [X.1] is obtained for each of the elements 21, where X is the number of the element 11 that was used to form the element 21. If the element 21 is a split meaning component 21, a combined meaning component 21, or a nested visual meaning component 21, then such element 21 is assigned a preliminary number [X.Y], where X is the number of the element 11 that was used to form the element 21, and Y is the index number of the split, combined, or nested visual meaning component 21 within the sequence of the IOCs, based on the location of the first component of the split, combined, or nested visual meaning component 21 in the element 11. In the second step, the resulting nested numbering (for example, but not limited to, 1.1, 2.1, 2.2, 3.1, 4.1, 4.2, 4.2, 5.1) allows to generate the index numbers of the elements 21 in the digitalized document 1, starting with the number 1 of the element with the nested number 1.1. Then, but not limited to, the following index number is assigned to the element 21 with the nested number 1.2 or, if there is no such nested number, with the nested number 2.1. This procedure is then repeated until all nested numbers are converted into the index numbers of the elements 21 in the digitalized document 1. Preferably, but not limited to, the analysis used to identify and form the elements 21 can be carried out in any way known from prior art and, accordingly, is not described any further. For example, but not limited to, such analysis can be performed either traditionally, by a language specialist, or using a software algorithm of a language (syntactic) processor, or through a traditional programming approach based on encoded immutable rules (a rule-based system). In addition, given enough samples, such analysis can be performed using a statistical processor (neural networks, AI systems) using neural network/AI training technologies.

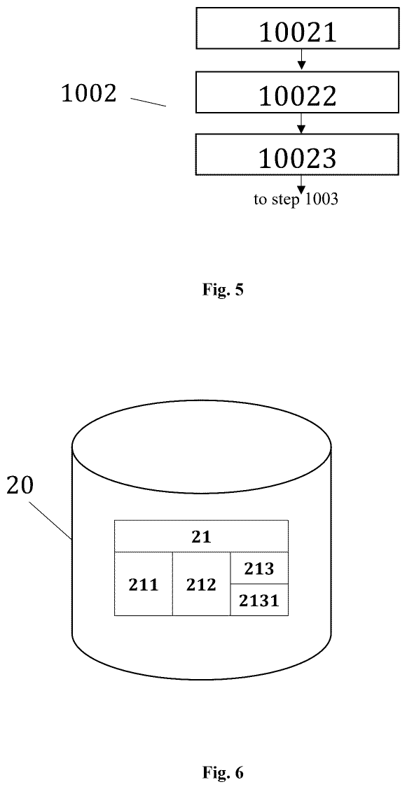

FIG. 5 illustrates an exemplary, non-limiting, overall scheme for the steps in step 1002 of generating a database of system features 20 of the meaning components 21 by, for example, but not limited to, identifying the system features in the first data structure 2 of meaning components 21, namely their formatting system characteristics 213 and functional system characteristics 213, as well as meanings 2131 of corresponding said system characteristics 213, in order to identify meaning components 21 with structural system features, and/or meaning components 21 with logical system features, and/or meaning components 21 with information system features, and/or meaning components 21 with requisite system features, and generating a database from the identified system features 20. Preferably, but not limited to, step 1002 further involves generating 10021 system features of the meaning components 21, wherein the identification data of each of the meaning components 21 of the information objects 11 in the digitalized document 1 are presented for system analysis to obtain system characteristics 213 for all the meaning components 21, along with their meanings 2131; and generating 10022 a database of system features 20 of the meaning components 21 of the information objects 11 in the digitalized document 1, wherein all system characteristics 213 with corresponding meanings 2131, obtained for each of the meaning components 21, can be system features.

FIG. 6 illustrates an exemplary, non-limiting, general diagram of a generated database of system features 20 (DBSF 20), which is a database of system features 20 of meaning components 21 of information objects 11 in a digitalized (electronic) document 1. Preferably, but not limited to, system characteristics 213 of meaning components 21 of information objects 11 in the digitalized document 1 comprise formatting characteristics and functional characteristics. In addition, preferably, but not limited to, the plurality of meanings 2131 of all system characteristics 213 of each of the meaning components 21 of information objects 11 in the digitalized document 1 is a distinguishing system feature of each of the meaning components 21 of information objects 11 in the digitalized document 1. Preferably, but not limited to, formatting characteristics describe formatting features of meaning components 21 of information objects 11 in the digitalized document 1, which can be classified, for example, but not limited to, into nested levels, such as kind, type, and subtype. In addition, the formatting kind of said meaning components 21 can preferably, but not limited to, have the following values: a text information object of the document, or a visual information object of the document; the formatting type of said meaning components 21 can preferably, but not limited to, have the following values: stringed (machine-readable text (words/numbers)), listed (machine-readable text (words/numbers)), tabular (machine-readable text (words/numbers)), imaged (photo, drawing, logo, picture), or handwritten (non-machine-readable text (words/numbers)); the formatting subtype of said meaning components 21 can preferably, but not limited to, have the following values: a regular linguistic construct (a language sentence), a special linguistic construct (a linguistic construct that combines language elements with the way of data structuring and/or visual information objects), a reconstructible linguistic construct (a way of data structuring that has a logical basis, which can be used to recreate a linguistic construct equivalent to the information contained in the structured data), or a non-linguistic construct. Preferably, but not limited to, functional characteristics indicate a plurality of functional features of meaning components 21 of information objects 11 in the digitalized document 1, which may include, for example, but not limited to: structural system features (structural hierarchy of the document), logical system features (main semantic content), information system features (additional or technical content), or meta system features (document metadata). Functional characteristics indicate, but not limited to, the functional roles of said meaning components 21, which include, for example, but not limited to: a structural role (meaning components 21 with structural system features), a logical role (meaning components 21 with logical system features), an informational role (meaning components 21 with information system features), or a meta role (meaning components 21 with document metadata features, i.e. requisite details).

System characteristics 213 and their meanings 2131 for meaning components 21 of information objects 11 in the digitalized document 1 are generated in step 10021, preferably, but not limited to, by means of a complex structural and linguistic analysis of each meaning component 21 of information objects 11 in the digitalized document 1, wherein, for example, but not limited to, the components (IOCs) of the information object 11 that forms the meaning component 21 are analyzed in terms of the aforementioned system features. Based on the system analysis of the aforementioned IOCs of the meaning component 21, preferably, but not limited to, system characteristics 213 are generated and added into the DBSF 20 as a list of system characteristics 213 with meanings 2131 in step 10022. For example, but not limited to, the meaning component 21, which has the meaning 211 of “Chapter 1: General Provisions”, may have the following system features, which are represented by the following system characteristics 213 with values 2131: formatting kind—“text IOC”; formatting type—“stringed machine-readable text”; formatting subtype “regular linguistic construct”; functional features—“structural organization of a document”; functional role—“structural”. Such analysis can be carried out in any way known from prior art and, accordingly, is not described any further. For example, but not limited to, such analysis can be performed either traditionally, by a language specialist, or using a software algorithm of a language (syntactic) processor, or through a traditional programming approach based on encoded immutable rules (a rule-based system). In addition, given enough samples, such analysis can be performed using a statistical processor (neural networks, AI systems) using neural network/AI training technologies. Preferably, but not limited to, a database of system features 20 (DBSF 20) containing the meaning components 21 of the information objects 11 from the digitalized document 1 is formed from the identified system characteristics 213 of the meaning components 21 of the information objects 11 from the digitalized document 1 and their meanings 2131, wherein the system characteristics 213 and their meanings 2131 form the system features of said meaning components 21.

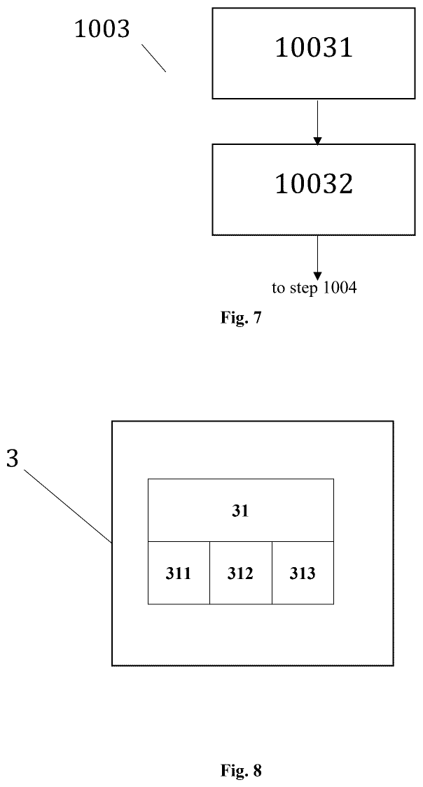

FIG. 7 illustrates an exemplary, non-limiting, overall scheme for the steps in step 1003 of generating the second data structure 3 of SDA. Preferably, but not limited to, step 103 further involves identifying and generating 10031 the elements 31 of second data structure 3, represented by integrated meaning components 31 of information objects 11 in the digitalized document 1, either grouped meaning components 21 from the first data structure 2 with matching system features or grouped meaning components 21 from the first data structure 2 with unique system features, as well as comprising identification data of said integrated meaning components 31, represented by non-repeating varieties of said meaning components 21 with either matching system features or unique system features, meanings of said meaning components 21 with either matching system features or unique system features, and their index numbers in the digitalized document 1, wherein such meaning components 21 with either matching system features or unique system features form said integrated meaning components 31; and generating 10032 the second data structure 3 from the identified and generated elements 31 of the second data structure 3, and their identification data.

FIG. 8 illustrates an exemplary, non-limiting, general diagram of a generated second data structure. Preferably, but not limited to, the second data structure 3 contains elements 31, representing said integrated meaning components 31 of the digitalized (electronic) document 1 and their identification data. The elements 31 of the second data structure 3 of the SDA are said integrated meaning components 31 of the information objects 11 of the digitalized document 1 and their identification data, which include meanings 311 of the integrated meaning components 31 in the digitalized document 1, their index numbers 312 and non-repeating varieties 313. Said integrated meaning components 31 of the information objects 11 of the digitalized document 1 are, preferably, but not limited to, grouped meaning components 21 from the first data structure 2 with matching or unique system features. In addition, the system features of the meaning components 21 are the system characteristics 213 and their meanings 2131; unique system features are such that occur only in one meaning component 21 of the digitalized document 1; and matching system features are such that occur in at least two meaning components 21 of the digitalized document 1. For example, but not limited to, the element 31 may have the following system features: Text IOC. Tabular machine-readable text. Reconstructible linguistic structure. Basic semantic information features. Logical functional role. Preferably, but not limited to, meanings 311 of integrated meaning components 31 are meanings 211 of meaning components 21 with matching or unique system features, wherein said meaning components 21 with matching or unique system features constitute said integrated meaning components 31. Preferably, but not limited to, the index numbers 312 of said integrated meaning component 31 are the index numbers 212 of meaning components 21 with matching or unique system features, wherein said meaning components 21 with matching or unique system features constitute said integrated meaning components 31. The elements 31 of the second data structure 3 do not have unique names and can be referred to as, for example, but not limited to, ISC1, ISC2, ISC3, ISCn, where n≥1 is the index of the element 31 in the digitalized document 1, starting with 1 for each element 31 in the digitalized document 1. Preferably, but not limited to, the non-repeating varieties 313 of integrated meaning components 31 in the digitalized document 1 are the non-repeating varieties of meaning components 21, from which the elements 31 are formed. In addition, non-repeating varieties of meaning components 21 include all unique system features of all meaning components 21 in the digitalized document 1. For example, but not limited to, a non-repeating variety 313 of integrated meaning components 31 comprises unique (if the element 31 consists of only one element 21) or matching (if the element 31 consists of two or more elements 21) system features of elements 21, from which elements 31 are formed, namely: Text IOC. Tabular machine-readable text. Reconstructible linguistic structure. Basic semantic information features. Logical functional role. Preferably, but not limited to, the elements 31 of the second data structure 3 of the SDA are identified in step 1031 through comparative analysis of meanings 2131 of the system characteristics 213 of the meaning components 21 of the information objects 11 of the digitalized document 1. In addition, the index number 312 of the element 31 and its non-repeating variety 313 are identified at the same time. For example, but not limited to, the elements 31, as well as their index numbers 312 and non-repeating varieties 313 of element 31, may be identified in the following order. At the first stage, all unique elements 21, i.e., elements that have unique (non-repeating) meanings of system characteristics 2131 are identified in the list of elements 21 of the first data structure 2. At the second stage, all identified unique elements 21 are submitted as elements 31 and numbered with index numbers starting from 1, wherein number 1 is assigned to the element 21, which has the minimum index number 212, number 2 is assigned to the element 21, the index number 212 of which is higher than that of the element 21 submitted as the element 31 with index number 1, but at the same time lower than that of other unique elements 21. And so on, until all the unique elements 21 are assigned their index number as elements 31. At the third stage, among the elements 21 of the first data structure that have not yet been identified as elements 31, elements 21 are searched for, which are identical in their system features to the elements 21 already identified as elements 31 at the second stage. The elements 21 thus identified are attached to corresponding elements 31 (grouped elements 21 with system features identical to the system features of the identified element 21), therefore associating all elements 21 of the first data structure with one or another element 31 formed at the second stage.

System features of elements 21, if necessary, but not limited to, are identified by sending a query to the DBSF 20 to obtain meanings 2131 of system characteristics 213 of meaning components 21 of information objects 11 of the digitalized document 1. In addition, as was described above, but not limited to, system features of the element 21 include at least formatting and functional characteristics of meaning components 21 of information objects 11 in the digitalized document 1. Meanings 311 of elements 31 are identified, but not limited to, after all elements 31 of the second data structure have been identified, i.e. after all elements 21 of the first data structure 2 have been associated with one or another identified element 31 (element 31 with one or another index number and with unique or matching system features of elements 21 that form the identified element 31). In addition, meanings 311 of said integrated meaning component 31 correspond to meanings 211 of all the elements 21 that form the identified element 31 of the second data structure 3. For example, but not limited to, the index numbers 312 of elements 31 of the second data structure 3 can be determined in the following way. At the first stage, index number 1 is assigned to the element 31, which contains the meaning component 21 with the lowest index number 212. At the second stage, the remaining unnumbered elements 31 are searched for an element 31, which contains a meaning component 21, the index number 212 of which is higher than that of the element 31 number 1, but lower than that of other elements 31 with no assigned index numbers. Such element 31 receives index number 2. At the third stage, the procedure of the second stage is repeated in order to determine the element 31 to be assigned index number 3, and so forth, until there will remain only one unnumbered element 31 in the second data structure of the document. At this point, the last unnumbered element 31 is assigned an index number that is one higher than the previous index number. Such comparative analysis used to identify and form the elements 31 can be carried out in any way known from prior art and, accordingly, is not described any further. For example, but not limited to, such analysis can be performed either traditionally, by a language specialist, or using a software algorithm of a language (syntactic) processor, or through a traditional programming approach based on encoded immutable rules (a rule-based system). In addition, given enough samples, such analysis can be performed using a statistical processor (neural networks, AI systems) using neural network/AI training technologies.

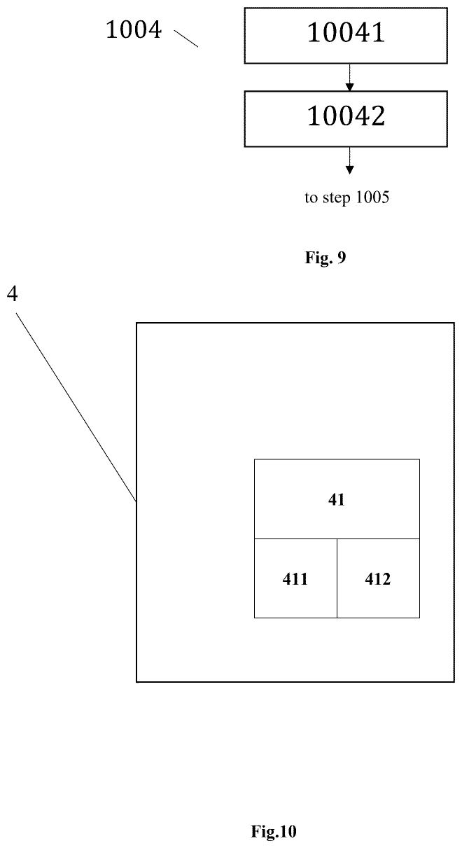

FIG. 9 illustrates an exemplary, non-limiting, overall scheme for the steps in step 1004 of generating the third data structure 4 of SDA. Step 1004 further involves identifying and generating 10041 the elements 41 of the third data structure 4, represented by linguistic constructs 41, which are said integrated meaning components 31 of information objects 11 in the digitalized document 1 contained in the second data structure 3, wherein said integrated meaning components 31 have system features of text-logical meaning components, as well as comprising identification data of said linguistic constructs 41, which comprises meanings 411 of the linguistic constructs 41 and their index numbers 412 in the digitalized document 1, wherein the linguistic constructs 41 in the digitalized document 1 can be represented by either regular linguistic constructs 41 from the third data structure 4, which are language sentences, or special linguistic constructs 41 from the third data structure 4, which are lists or rolls, or reconstructible linguistic constructs 41 from the third data structure 4, which are tables comprised of at least two rows and two columns, wherein at least one row contains column headings and/or at least one column contains row headings respectively, or a combination thereof; generating 10042 the third data structure from the elements 41 of the third data structure 4, identified and generated in step 10041, and their identification data.

FIG. 10 illustrates an exemplary, non-limiting, general diagram of a generated third data structure 4 of SDA. The third data structure 4 comprises linguistic constructs 41 as well as their identification data, which include meanings 411 of the linguistic constructs 41 and their index numbers 412 in the digitalized document 1. Preferably, but not limited to, the third data structure 4 of the SDA comprises linguistic constructs 41, namely integrated meaning components 31 of the digitalized (electronic) document 1, which are contained in the second data structure 3, having the system features of text-logical meaning components, i.e., text-logical integrated meaning components 31. For example, but not limited to, text-logical integrated meaning components may have the following system features of their text-logical meaning components: meanings 2131 of the system characteristics 213 of the meaning components 21 that form the element 31: Text IOC. Listed machine-readable text. Special linguistic construct. Basic semantic information features. Logical functional role. Preferably, but not limited to, meanings 411 of linguistic constructs 41 are identical to meanings of text-logical integrated meaning components (integrated meaning components 31 of information objects 11 of the digitalized document 1 contained in the second data structure 3, and having system features of text-logical meaning components). Preferably, but not limited to, the index numbers 412 of linguistic constructs 41 are the index number of the text-logical integrated meaning component in the digitalized document 1.

Preferably, but not limited to, the element 41 of the third data structure 4 of the SDA is identified and formed in step 10041 by carrying out a comparative analysis of meanings 2131 of system characteristics 213 of meaning components 21 of information objects 11 of the digitalized document 1 that are part of the elements 31 of the second data structure 3. The object of comparison in meanings 2131 of system characteristics 213 is the formats and functional roles of meaning components 21. In addition, but not limited to, all the elements 21 included in the element 31 have identical formats and functional roles. Therefore, in order to conduct a comparative analysis of the element 31, it is sufficient to conduct a comparative analysis of one of the elements 21 that make up the element 31. In case meanings of the system characteristics of the element 21 that is being analyzed contain “Text format” and “Logical functional role”, then the analyzed element 31 that contains the analyzed element 21 is considered a text-logical integrated system characteristic, identified as an element 41 (a linguistic construct), and added to the third data structure 3 of the SDA. Preferably, but not limited to, the system features of the elements 21 are identified, if necessary, by sending a query to the DBSF 10, which is formed in step 1003, the query comprising identification data of the meaning components 21, to obtain meanings 2131 of the system characteristics 213 of the meaning components 21 of the information objects 11 of the digitalized document 1. In addition, as was described above, system features of the element 21 include at least formatting and functional characteristics of meaning components 21 of information objects 11 in the digitalized document 1. Preferably, but not limited to, the meaning 411 of each element 41 (linguistic construct) is identical to the meaning 311 of said integrated meaning components 31, which has been identified as a text integrated meaning component and identified as element 41 (linguistic construct).

In the data structure, elements 41, for example, but not limited to, can be referred to as LK1, LK2, LK3, LKn, where n≥1 is the index number 412 of the element 41 in the digitalized document 1. For example, but not limited to, the index numbers 412 of elements 41 of the third data structure 4 can be determined in the following way. At the first stage, the element 41, which has been formed from said integrated meaning component 31 with the lowest index number 312, is assigned index number 1. At the second stage, the remaining unnumbered elements 41 are searched for an element 41, which has been formed from said integrated meaning component 31, the index number 312 of which is higher than that of the element 41 number 1, but lower than that of other elements 41 with no assigned index numbers. Such element 41 receives index number 2. At the third stage, the procedure of the second stage is repeated in order to determine the element 41 to be assigned index number 3, and so forth, until there will remain only one unnumbered element 41 in the second data structure of the document. At this point, the last unnumbered element 41 is assigned an index number that is one higher than the previous index number. Such comparative analysis used to identify and form the elements 41 can be carried out in any way known from prior art and, accordingly, is not described any further. For example, but not limited to, such analysis can be performed either traditionally, by a language specialist, or using a software algorithm of a language (syntactic) processor, or through a traditional programming approach based on encoded immutable rules (a rule-based system). In addition, given enough samples, such analysis can be performed using a statistical processor (neural networks, AI systems) using neural network/AI training technologies. The third data structure 4 of the SDA is generated in step 10042 by combining the elements 41 of the third data structure 4 and their identification data in a single data structure using methods and principles known from prior art and, accordingly, not described any further.

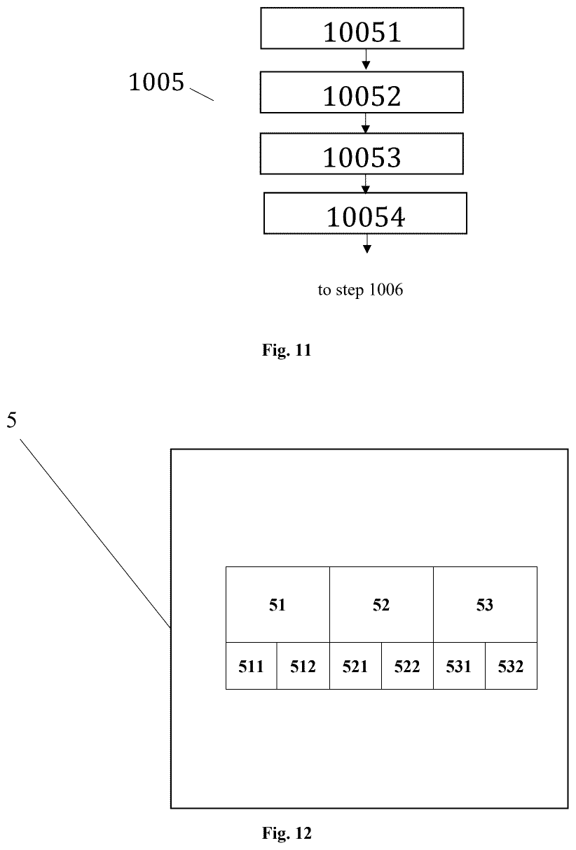

FIG. 11 illustrates an exemplary, non-limiting, overall scheme for the steps in step 1005 of generating the fourth data structure 5 of SDA. Preferably, but not limited to, step 1005 further involves identifying and generating 10051 first elements 51 of the fourth data structure 5, as well as their identification data, which comprises meanings 511 of each of the first elements 51 of the fourth data structure 5 and their index numbers 512 in the fourth data structure 5, wherein said first elements 51 are represented by language sentences generated from the elements 41 of the third data structure 4, which comprises regular linguistic constructs 41, by matching said language sentences from the fourth data structure 5 with the regular linguistic constructs 41 from the third data structure 4; identifying and generating 10052 the second elements 52 of the fourth data structure 5, as well as their identification data, which comprises meanings 521 of each of the second elements 52 of the fourth data structure 5 and their index numbers 522 in the fourth data structure 5, wherein said second elements 52 are represented by language sentences generated from the elements 41 of the third data structure 4, which comprises special linguistic constructs 41, by transforming the special linguistic constructs 41 into said language sentences from the fourth data structure 5, wherein special linguistic constructs 41 may be represented by a list or a roll; identifying and generating 10053 the third elements 53 of the fourth data structure 5, as well as their identification data, which comprises meanings 531 of each of the third elements 53 of the fourth data structure 5 and their index numbers 532 in the fourth data structure 5, wherein said third elements 53 are represented by language sentences generated from the elements 41 of the third data structure 4, which comprises reconstructible linguistic constructs 41, by using the data contained therein to recreate separate language sentences from the fourth data structure 5, wherein the reconstructible linguistic constructs are tables that show signs of logical data structuring; and generating 10054 the fourth data structure 5 from first elements 51, second elements 52, and third elements 53 of the fourth data structure 5, and their identification data.

FIG. 12 illustrates an exemplary, non-limiting, general diagram of a generated fourth data structure 5. Preferably, but not limited to, the fourth data structure 5 (DS 5) comprises the first element 51, the second element 52, and the third element 53, which are language sentences, as well as their identification data, which include, for example, but not limited to: meanings 511 and index numbers 512 of the first element 51 of DS 5; meanings 521 and index numbers 522 of the second element 52 of DS 5; and meanings 531 and index numbers 532 of the third element 53 of DS 5. Preferably, but not limited to, elements 51, 52, 53 of the fourth data structure 5 are language sentences formed from various linguistic constructs 41 contained in the third data structure 4. Preferably, but not limited to, said language sentences in DS 5, formed from regular linguistic constructs 41, are designated as elements 51, wherein, but not limited to, a regular linguistic construct 41 is grouped syntactically connected words, i.e., a language sentence. Preferably, but not limited to, language sentences, formed by transforming special linguistic constructs 41, are designated as elements 52 in DS 5, wherein, but not limited to, a special linguistic construct 41 is a combination of a regular linguistic construct 41 (grouped syntactically connected words, i.e. a language sentence) and a data organization system (a list, or a table containing one row or one column), represented, for example, but not limited to, a list or a roll. Preferably, but not limited to, language sentences, formed by recreating individual sentences from reconstructible linguistic constructs 41, are designated as elements 53 in DS 5, wherein, but not limited to, a reconstructible linguistic construct 41 is a table containing logically organized data. As a rule, such tables have to include, but not limited to, at least two rows and two columns, wherein at least one row and/or column must contain the designation of data in the respective row(s) and/or column(s), i.e., row and column headings. Such tables have data organization features, which can be described by the following logical formulas: IF< . . . >, THEN < . . . >, or (IF < . . . > AND IF < . . . >), THEN < . . . >. For example, but not limited to, in order to form the element 51, the system characteristics of the elements 21 that make up the element 41 may have the following values: Text IOC. Stringed machine-readable text. Regular linguistic construct. Basic semantic information features. Logical functional role. For example, but not limited to, in order to form the element 52, the system characteristics of the elements 21 that make up the element 41 may have the following values: Text IOC. Listed machine-readable text. Special linguistic construct. Basic semantic information features. Logical functional role. For example, but not limited to, in order to form the element 53, the system characteristics of the elements 21 that make up the element 41 may have the following values: Text IOC. Tabular machine-readable text. Reconstructible linguistic structure. Basic semantic information features. Logical functional role.

In the fourth data structure 5, elements 51, for example, but not limited to, can be referred to as LSx1, LSx2, LSx3, LSxn, where x is the index number of the meaning component 41 in the third data structure 4, the component containing an ordinary linguistic construct 41, associated with the language sentence 51, and n≥1 is the index number of the element 51 (the language sentence associated with the ordinary linguistic construct 41) in said meaning component 41, starting with 1. In the fourth data structure 5, elements 52, for example, but not limited to, can be referred to as LSx1, LSx2, LSx3, LSxn, where x is the index number of the meaning component 41 in the third data structure 4, the component containing a special linguistic construct 41, used to form the language sentence 52, and n≥1 is the index number of the element 52 (the language sentence 52 formed from the special linguistic construct 41) in said meaning component 41, starting with 1. In the fourth data structure 5, elements 53, for example, but not limited to, can be referred to as LSx1, LSx2, LSx3, LSxn, where x is the index number of the meaning component 41 in the third data structure 4, the component containing a reconstructible linguistic construct 41, from which the language sentence 53 has been recreated, and n≥1 is the index number of the element 53 (the language sentence 53, recreated using the data of the reconstructible linguistic construct 41) in said meaning component 41, starting with 1. Preferably, but not limited to, since the numbering of all language sentences 51, 52, 53 from the fourth data structure 5 is common for all language sentences 51, 52, 53 from the fourth data structure 5, regardless of whether the first, second or third element of the fourth data structure 5 is a separate language sentence 51, 52, 53, the index numbers of all language sentences 51, 52, 53 from the fourth data structure 5 are assigned, based on the established preliminary index numbers in the xn format, in the format LS1, LS2, LS3, LSy, where y is the index number of the element 51, 52, 53 of the fourth data structure 5 in the fourth data structure 5. In addition, but not limited to, the lowest number is assigned to language sentences 51, 52, 53 from the fourth data structure 5, which have the lowest preliminary index numbers in the xn format. When establishing the index number, the index x is considered primary, and the index n is considered secondary. The lowest sequence is assigned to the element 51, 52, 53 of the fourth data structure 5 with the lowest x index, and if several elements 51, 52, 53 of the fourth data structure 5 have the same index, then the lowest index number is assigned to the element 51, 52, 53 of the fourth data structure 5 with the lowest n index in the preliminary index number. Preferably, but not limited to, elements 51 of the fourth data structure 5 are identified and formed in step 10051 by identifying the signs of the end of a language sentence and the signs of the beginning of a language sentence in meanings 511 of the element 51 of the fourth data structure 5. Such signs are formed and stored in a special user database (UDB) and make up a list of text characters (text elements), signifying the beginning or end of a language sentence when present in ordinary linguistic constructs 41 of the third data structure 4. For example, but not limited to, symbols (text elements) that can be signs of the beginning of a sentence include a word with a capital letter, a number, the first word (number) in the meaning component, and so on. For example, but not limited to, symbols (text elements) that can be signs of the end of a sentence include punctuation marks (full stop, semicolon) followed by a space, the last word (number, punctuation mark) in the meaning component, and so on.

Preferably, but not limited to, in order to identify elements 51, the elements 41 are first identified, for which meanings 2131 of the system characteristics 213 of the meaning components 21 that make up the element 41 meet the aforementioned requirements for the first element 51 of the fourth data structure 5. Then, in the elements 41 meeting said requirements, signs of the end of a language sentence and signs of the beginning of a language sentence are identified. Based on the results of identifying the end and beginning signs, the element 41 can be divided into elements 51, which represent language sentences 51 contained in element 41. Such analysis of the elements 41 used to identify and form the elements 51 can be carried out in any way known from prior art and, accordingly, is not described any further. For example, but not limited to, such analysis can be performed either traditionally, by a language specialist, or using a software algorithm of a language (syntactic) processor, or through a traditional programming approach based on encoded immutable rules (a rule-based system). In addition, given enough samples, such analysis can be performed using a statistical processor (neural networks, AI systems) using neural network/AI training technologies. In addition, preferably, but not limited to, the system characteristics of meaning components that make up elements 41 of the third data structure 4 of the SDA and meanings thereof are identified, when necessary, by sending a request to the database of system features 20 (DBSF 20) that is generated in step 1003, wherein the request comprises identification data of the meaning components that make up the element 41, and receiving meanings 2131 of the system characteristics 213 of the meaning components 21 of the information objects 11 in the digitalized document 1 that make up the element 41. In addition, as was described above, system features of the element 51 include at least meanings 2131 of the formatting and functional characteristics 213 of meaning components 21 of information objects 11 in the digitalized document 1, which form the elements 41 that meet the requirements of system features of elements 51.

Preferably, but not limited to, elements 52 of the fourth data structure 5 are identified and formed in step 10052 by identifying the signs of the first part of a combined language sentence and the signs of the second part of a combined language sentence in meanings 521 of the element 52 of the fourth data structure 5. Such signs are formed and stored in a special user database (UDB) and make up a list of text symbols (text elements), signifying the first and second parts of a combined language sentence when present in an electronic text data array (logical data array) consisting of special linguistic constructs. For example, but not limited to, symbols (text elements) that can be signs of the beginning of the first part a combined sentence include a word with a capital letter, a number, the first word (number) in the meaning component, and so on. For example, but not limited to, symbols (text elements) that can be signs of the end of the first part a combined sentence include a punctuation mark (colon) followed by a space, or a newline symbol. For example, but not limited to, symbols (text elements) that can be signs of the beginning of the second part a combined sentence include a word with a small letter, a number, the preceding symbol (punctuation mark, such as colon or semicolon). For example, but not limited to, symbols (text elements) that can be signs of the end of the second part a combined sentence include a punctuation mark (semicolon or full stop) followed by a space, or a newline symbol. A practical example of the formation of combined language sentences from elements 41, which comprises a list or a roll, can be demonstrated by the following example. If the roll (element 41) has the following text: “For the goods to be transferred, the buyer must provide the receipt, the power of attorney, and the ID of the authorized person.”, then the following elements 52 can be formed from it: “For the goods to be transferred, the buyer must provide the receipt”; “For the goods to be transferred, the buyer must provide the power of attorney”; and “For the goods to be transferred, the buyer must provide the ID of the authorized person”. Preferably, but not limited to, in order to identify elements 52, the elements 41 are first identified, for which meanings 2131 of the system characteristics 213 of the meaning components 21 that make up the element 41 meet the aforementioned requirements for the second element 52 of the fourth data structure 5. Then, in the elements 41 corresponding to the above requirements, signs of the beginning of the first part of a combined language sentence and signs of the end of the first part of a combined language sentence are identified, as well as signs of the beginning of the second part of a combined language sentence and signs of the end of the second part of a combined language sentence. Based on the results of the identification of all said features for the identification of elements 52, element 41 is first divided into parts of elements 52, from which elements 52 are formed, representing the combined language sentences contained in element 41. Such analysis of the elements 41 used to identify and form the elements 52 can be carried out in any way known from prior art and, accordingly, is not described any further. For example, but not limited to, such analysis can be performed either traditionally, by a language specialist, or using a software algorithm of a language (syntactic) processor, or through a traditional programming approach based on encoded immutable rules (a rule-based system). In addition, given enough samples, such analysis can be performed using a statistical processor (neural networks, AI systems) using neural network/AI training technologies. Preferably, but not limited to, the system characteristics 213 of meaning components 21 that make up elements 41 of the third data structure 4 of the SDA and meanings thereof are identified, when necessary, by sending a request to the database of system features 20 (DBSF 20) that is generated in step 1003, wherein the request comprises identification data of the meaning components 21 that make up the element 41, and receiving meanings 2131 of the system characteristics 213 of the meaning components 21 of the information objects 11 in the digitalized document 1 that make up the element 41. In addition, as was described above, system features of the element 52 include at least meanings 2131 of the formatting and functional characteristics 213 of meaning components 21 of information objects 11 in the digitalized document 1, which form the elements 41 that meet the requirements of system features of elements 52.

Preferably, but not limited to, elements 53 of the fourth data structure 5 are identified and formed in step 10053 by identifying the signs of the first part of a reconstructed language sentence and the signs of the second part of a reconstructed language sentence in meanings 531 of the element 53 of the fourth data structure 5. Such signs are formed and stored in a special user database (UDB) and make up a list of electronic page code symbols (text and table elements), signifying the first and second parts of a reconstructible language sentence when present in an electronic text data array (logical data array) consisting of reconstructible linguistic constructs. For example, but not limited to, symbols (text and table symbols) that are signs of the name of the table can be: a text row above the table; a cell of the first row of the table containing text, which corresponds in width to all cells in the second row; and so on. For example, but not limited to, symbols (text and table symbols), which are signs of the names of fields (columns) of the table can be: symbols indicating the number of fields in the first row of the table, if there are more than one; symbols indicating the number of fields in the second row of the table, if there are more than one (in case there is the first row of the table name); symbols indicating the names of the fields of the table located on several rows, and so on. For example, but not limited to, the symbols (text and table symbols) that can signify the names of table rows include symbols indicating the number of table rows; symbols indicating the number of table rows containing the names of table fields; symbols indicating the number of table rows containing the names of rows, and so on. For example, but not limited to, symbols (text-table symbols) that can signify table meanings include symbols indicating table cells that do not relate either to the name of the table or to the names of fields (columns) or rows of the table, and so on.

A practical example of the formation of recreated language sentences from elements 41, which comprises a data table, can be demonstrated by the following example. Assume that Table 1 (element 41 containing data with meaning components having the following system feature values: Tabular machine-readable text. Reconstructible linguistic construct.) looks as follows:

TABLE 1

| | | Class of | Side |
|---|---|---|---|
| Processing method | Roughness, μm | accuracy | allowance, mm |
| Rough turning | 160 . . . 80 | 14-12 | 1.5 . . . 3.5 |
| Final turning | 40 . . . 10 | 8-10 | 0.25 . . . 0.4 |
| Fine turning | 10 . . . 1.6 | 8-6 | 0.14 . . . 0.2 |

Then, the recreated linguistic sentences 53 can be as follows: “If the processing method is rough turning, then the roughness should be between 160 and 80 μm”; “If the processing method is rough turning, then the class of accuracy should be between 14 and 12”; “If the processing method is rough turning, then the side allowance should be between 1.5 and 3.5 μm”; “If the processing method is final turning, then the roughness should be between 160 and 80 μm”; “If the processing method is final turning, then the class of accuracy should be between 14 and 12”; “If the processing method is final turning, then the side allowance should be between 1.5 and 3.5 μm” Preferably, but not limited to, in order to identify elements 53, the elements 41 are first identified, for which meanings 2131 of the system characteristics 213 of the meaning components 21 that make up the element 41 meet the aforementioned requirements for the third element 51 of the fourth data structure 5. Then, in the elements 41 corresponding to the above requirements, signs of the name of the table, signs of the names of the fields (columns) of the table, as well as signs of the names of the rows of the table and signs of the values of the table are revealed. Based on the results of the identification of all said features for the identification of elements 53, element 41 is first divided into parts of elements 53, from which elements 53 are formed, representing the recreated language sentences 53 contained in element 41. Such analysis of the elements 41 used to identify and form the elements 53 can be carried out in any way known from prior art and, accordingly, is not described any further. For example, but not limited to, such analysis can be performed either traditionally, by a language specialist, or using a software algorithm of a language (syntactic) processor, or through a traditional programming approach based on encoded immutable rules (a rule-based system). In addition, given enough samples, such analysis can be performed using a statistical processor (neural networks, AI systems) using neural network/AI training technologies. Preferably, but not limited to, the system characteristics 213 of meaning components 21 that make up elements 41 of the third data structure 4 of the SDA and meanings thereof are identified, when necessary, by sending a request to the database of system features 20 (DBSF 20) that is generated in step 1003, wherein the request comprises identification data of the meaning components that make up the element 41, and receiving meanings 2131 of the system characteristics 213 of the meaning components 21 of the information objects 11 in the digitalized document 1 that make up the element 41 of the third data structure of the SDA. In addition, as was described above, system features of the element 53 include at least meanings 2131 of the formatting and functional characteristics 213 of meaning components 21 of the information object 11 in the digitalized document 1, which form the elements 41 that meet the requirements of system features of elements 53.

Preferably, but not limited to, the fourth data structure 5 is generated in step 10054 by combining the elements 51, 52, and 53 of the fourth data structure 5 and their identification data in a single data structure using methods and principles known from prior art and, accordingly, not described any further.

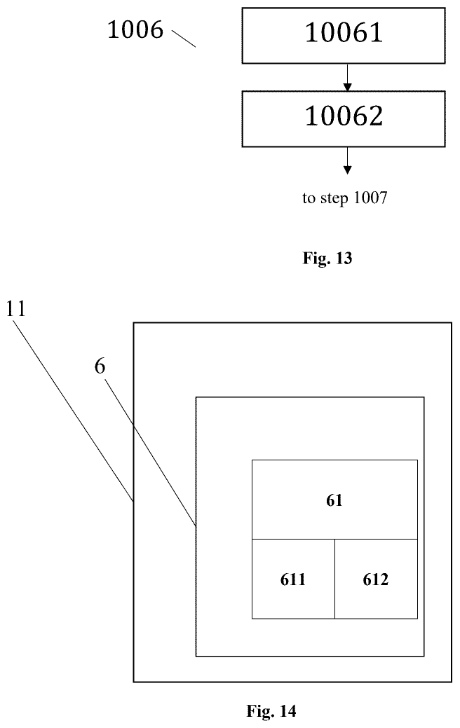

FIG. 13 illustrates an exemplary, non-limiting, overall scheme for the steps in step 1006 of generating the fifth data structure 6. Preferably, but not limited to, step 1006 further involves identifying 10061 the elements 61 of said language sentences from the fifth data structure 6, as well as comprising identification data of said elements 61, which comprises meanings 611 of the elements 61 and their index numbers 612 in corresponding language sentences 51, 52, 53 from the fourth data structure 5, wherein such language sentences 51, 52, 53 are contained in linguistic constructs 41 of the third data structure 4, and wherein the elements 61 of the fifth data structure 6 are text elements 61 of the language sentence 51, 52, 53 from the fourth data structure 5; and generating 10062 the fifth data structure 6 from the identified elements 61 of the fifth data structure 6, and their identification data.

FIG. 14 illustrates an exemplary, non-limiting, general diagram of a generated fifth data structure 6. The fifth data structure 6 (fifth DS 6) contains text elements 61 of language sentences 51, 52, 53 from the fourth data structure 5 contained in linguistic constructs 41 of the third data structure 4 of the SDA, as well as their identification data, which comprises, for example, but not limited to, meanings 611 of text elements 61 in language sentences 51, 52, 53 from the fourth data structure 5 and their the index numbers 612. Preferably, but not limited to, said text elements 61 of language sentences 51, 52, 53 from the fourth data structure 5, being the elements 61 of the fifth data structure 6, represent various separate objects of corresponding linguistic sentence 51, 52, 53, for example, but not limited to: text elements of the first type (primary text elements), such as, for example, but not limited to, words, numbers, digits, indexes (structures made up of numbers and/or letters and/or signs); punctuation marks and so on, wherein said objects of a language sentence are separated within the sentence by spaces, except punctuation marks, which have no space on at least one side (before the punctuation mark); text elements of the second type (complex text elements), such as, for example, but not limited to, word forms or groups of words that are one object in accordance with the rules of morphology (a complex word form or a morphological homonym). For example, the words “in”, “in accordance” and “with” represent several primary TE, whereas they (grouped words) also form one complex text element “in accordance with”. In practice, the user independently sets criteria for text elements in advance, specifying the type of text elements of a language sentence that interests him. Preferably, but not limited to, the meaning 611 of the text element 61 is the set of all characters (letters, numbers, symbols, punctuation marks, spaces) that make up the element 61 in the language sentence 51, 52, 53. Preferably, but not limited to, the index number 612 of the text element 61 is the index number 612 of the text element 61 in the language sentence 51, 52, 53 from the fourth data structure 5. In the data structure, elements 6, for example, but not limited to, can be referred to as TE1.x, TE2.x, TE3.x, TEn.x, where n≥1 is the index number of the text element 61 in the language sentence 51, 52, 53 from the fourth data structure 5, and x≥1 is corresponding index number 512, 522, 532 of the language sentence 51, 52, 53 in the fourth data structure 5.

Preferably, but not limited to, text elements 61 of the fifth data structure 6 are identified and formed in step 10061 by analyzing the text and identifying (highlighting) individual text elements 61 according to their type and description, which should be known in advance. For example, but not limited to, such an analysis can be performed by highlighting words, numbers or indexes in a sentence separated from each other by a space, as well as by punctuation marks that are attached to said words, numbers and indexes. In addition, preferably, the last punctuation mark in the sentence is not taken into account and is not considered as a text element 61 of the language sentence 51 from the fourth data structure 5. Preferably, but not limited to, when identifying text elements 61 that are complex text elements 61, if such a type of text elements 61 has been previously established, a query is sent to separate databases (for example, but not limited to, to a plug-in electronic morphological dictionary) to confirm the composition of a complex text element 61 in order to further identify it as a text element 61 in the linguistic sentence 51 of the fourth data structure 5. Such analysis of said language sentences 51 from the fourth data structure 4 used to identify and form said text elements 61 can be carried out in any way known from prior art and, accordingly, is not described any further. For example, but not limited to, such complex analysis can be performed either traditionally, by a language specialist, or using a software algorithm of a language (syntactic) processor, or through a traditional programming approach based on encoded immutable rules (a rule-based system). In addition, given enough samples, such analysis can be performed using a statistical processor (neural networks, AI systems) using neural network/AI training technologies. Preferably, but not limited to, the fifth data structure 6 is generated in step 10062 by combining the elements 61 of the fifth data structure 6 and their identification data in a single data structure using methods and principles known from prior art and, accordingly, not described any further.

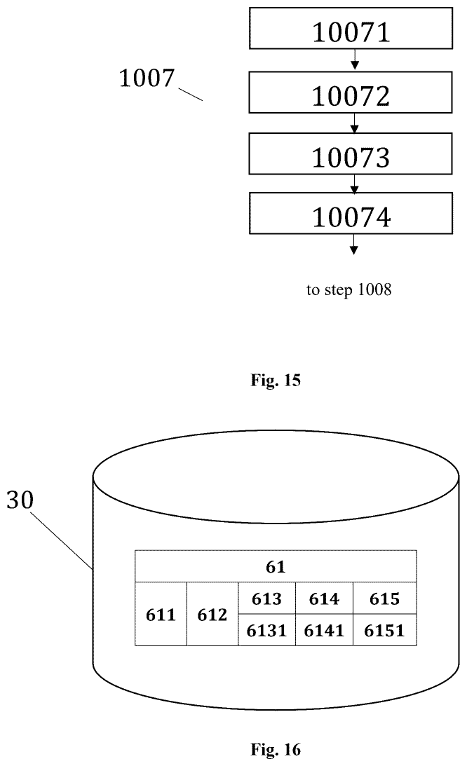

FIG. 15 illustrates an exemplary, non-limiting, overall scheme for the steps in step 1007 of generating a database of linguistic-logical-subject features 30 (DBLLSF 30), which is a database of linguistic-logical-subject features of text elements 61 of said language sentences 51, 52, and 53 that are part of the linguistic constructs 41 in the third data structure 4. Preferably, but not limited to, step 1007 further involves generating 10071 the first portion of linguistic-logical-subject features of said text elements 61 of said language sentences 51, 52, 53 from the fourth data structure 5, wherein the identification data of said text elements 61 from the fifth data structure 6, classified as words, are presented for linguistic analysis to obtain the linguistic parameters of said text elements 61, as well as meanings of said parameters; generating 10072 the second portion of linguistic-logical-subject features of said text elements 61 of said language sentences 51, 52, 53 from the fourth data structure 5, wherein the identification data of said text elements 61 from the fifth data structure 6, classified as words, together with their linguistic parameters and meanings thereof, are presented for logical analysis to obtain the logical parameters of said text elements 61 in each language sentence 51, 52, 53, as well as meanings of said parameters; generating 10073 the third portion of linguistic-logical-subject features of said text elements 61 of said language sentences 51, 52, 53 from the fourth data structure 5, wherein the identification data of said text elements 61 from the fifth data structure 6, classified as words, together with their linguistic parameters and meanings thereof, as well as their logical parameters and meanings thereof, are presented for subject analysis to obtain the subject parameters of said text elements 61 in the subject area, as well as meanings of said parameters; generating 10074 a database 20 of linguistic-logical-subject features 30 of said text elements 61 of said language sentences 51, 52, 53 from the fourth data structure 5, wherein said linguistic-logical-subject features are represented by the aforementioned linguistic parameters, logical parameters, and subject parameters and meanings thereof, which were obtained for each text element 61 in steps 10071, 10072, and 10073.

FIG. 16 illustrates an exemplary, non-limiting, general diagram of a generated database of linguistic-logical-subject features 30 (DBLLSF 30), which is a database of linguistic-logical-subject features of text elements 61 of the language sentence 51 from the fourth data structure 5. Preferably, but not limited to, the practical purpose of the DBLLSF 30 is to form two interrelated groups of features, namely linguistic and logical, and logical and subject features. Preferably, but not limited to, the first group (linguistic and logical characteristics) is necessary to isolate logical structures (resulting judgements, simple judgements, simple judgement components, i.e. concepts, signs of concepts, images) from the language sentence 51, 52, 53 to transform the language sentence into logical structures, representing, for example, but not limited to, simple judgements and resulting judgements. The second group (logical and subject characteristics) is required to form subject area-oriented structured information by correlating the logical objects of said logical structures with the subject area objects of the subject structures, i.e., objects and structures used in the specific subject area and established in the formal model of structural elements of the subject area. For example, but not limited to, such subject area can be law. In this case, the correlated subject structure will be a formalized model of the structural part of the legal norm (hypotheses, dispositions or sanctions), and the subject objects will be elements of the formal model of the structural part of the legal norm (FMSPLN elements), such as, for example, but not limited to, the subject of legal relations, the object of legal relations, the content of legal relations, and so on.

Preferably, but not limited to, the first part of the linguistic-logical-subject features 613 of text elements 61 of linguistic sentences 51, 52, 53 from the fourth data structure 5 consists of linguistic (morphological, syntactic and semantic) features, wherein, but not limited to, all meanings of all linguistic features of each of said text elements 61 of the language sentence 51, 52, 53 from the fourth data structure 5 together from their distinctive (unique) linguistic features in the language sentence 51, 52, 53 from the fourth data structure 5. Preferably, morphological features of text elements 61 of language sentences 51, 52, 53 from the fourth data structure 5 can be classified, for example, but not limited, into nested levels, such as kind, type, and subtype, wherein, preferably, morphological kinds of text elements 61 of language sentences 51, 52, 53 from the fourth data structure 5 include a word, a digit, a punctuation mark, and other signs; morphological types include part of speech (for words), the type of digit (Arabic or Roman), the type of punctuation mark (dot, comma, etc.), and other sign types; and morphological subtypes include gender, number, case, and other part-of-speech features for words, as well as number, binary code, index and the like for digits. Preferably, syntactic features of text elements 61 of language sentences 51, 52, 53 from the fourth data structure 5 include, for example, but not limited to, a syntactic role (predicate, subject, and so on), a syntactic parent (the main word in the syntactical structure), syntactic children (subordinate words), and compositional syntactic link (in case another text element has the same syntactic role and the syntactic parent). Preferably, semantic features of text elements 61 of language sentences 51, 52, 53 from the fourth data structure 5 include, for example, but not limited to, a semantic group (grouped words that can be attributed to one class, kind, type or subtype of real-world objects or actions if their features coincide), and a semantic status, which is the semantic meaning of a word or group of words within a phrase, i.e. a certain conceivable image (object or action). For example, but not limited to, the conceivable image of “absence of the seller at the consumer's location” consists of two top-level elements (terms): “absence of the seller” and “the consumer's location”, which have the following semantic statuses: the main element, which defines the meaning of the term, and the additional element, which adds to the previously meaning of the main term, respectively.

Preferably, but not limited to, the second part of the linguistic-logical-subject features 614 of said text elements 61 of a language sentence 51, 52, 53 from the fourth data structure 5 consists of logical features, wherein all meanings of all logical features of each of said text elements 61 of the language sentence 51, 52, 53 from the fourth data structure 5 together from their distinctive (unique) logical features in the language sentence 51, 52, 53 from the fourth data structure 5. Preferably, the following logical features of text elements 61 of language sentences 51, 52, 53 from the fourth data structure 5 can be distinguished, such as, but not limited to, the logical role of each word that forms text elements 61 in language sentences 51, 52, 53 from the fourth data structure 5. The logical role of a word is its logical position in a logical entity (a logical object) within a sentence, including, for example, but not limited to, a concept, an attribute, a term (part of an image), an image (part of a simple judgement), a simple judgement, a complex proposition. The logical role of a word in simple logical objects, such as the concept and the attribute, does not depend on the logical structure of a judgement, being a tag (index) that indicates what a given word means in a given simple logical object. For example, the word “law” is always a concept, while the word “federal” is always an attribute. The logical role of a word in more complex (composite) logical objects, such as a term and an image, depends on the formal model of the logical structure of a proposition (FMLSP), in relation to the elements (logical objects) of which the logical role of the word can be established.

Preferably, but not limited to, the linguistic and logical features can be generated only if the linguistic and logical data arrays contain correlated objects (objects that can be matched). An analysis can be performed to see whether it is possible to match the text element 61 of the sentence 51, 52, 53 with a logical object of the FMLSP. Such an analysis shows that if text elements can be logical objects such as a “sign of a concept” (for example, the word “established”), then individual text elements of a sentence do not correlate in any way with logical objects such as a “concept” expressed through grouped primary text elements 61 (for example, “violation of consumer rights”). Since the element (logical object) of the FMLSP can be not only a concept with an attribute (e.g. “established consumer right violation”, grouped four primary text elements), but also a much larger structure of syntactically connected words (e.g. a logical subject may have the following language representation: “responsibility to fulfill, within the limits of their powers, the judge's decision to conduct investigative work”), then it can be concluded that said text elements of a sentence can't be matched with logical objects. Preferably, but not limited to, in the sentence a logical object of the FMLSP can be matched with linguistic object, such as a syntactic unit (SU). A syntactic unit is a word or phrase (a syntactically connected group of words). The flexible nature of syntactic units allows them to match any logical objects that form the FMLSP. Thus, the identified actual linguistic and logical characteristics are important from a practical point of view not so much for describing individual text elements 61, but rather for actual syntactic units (actual SUs), which consist of one or more text elements 61 of the sentence 51, 52, 53. The actual SU is an actual list of syntactic units that correlate with the actual logical objects of the actual FMLSP. Actual SUs and actual FMLSPs are predetermined and stored in the first user database (first UDB), which is a database of actual syntactic units (actual SUs), actual logical objects (actual LOs) and actual FMLSP, wherein a table of correlations between actual SUs and actual LOs is included.

Preferably, but not limited to, the third part of the linguistic-logical-subject features 615 of said text elements 61 of a language sentence 51, 52, 53 from the fourth data structure 5 consists of subject features, wherein all meanings of all subject features of each of said text elements 61 of the language sentence 51, 52, 53 from the fourth data structure 5 together from their distinctive (unique) subject features in the language sentence 51, 52, 53 from the fourth data structure 5. Preferably, the subject characteristics indicate the subject features of said text elements 61 of the language sentence 51, 52, 53 from the fourth data structure 5, which include, for example, but not limited to, the following subject characteristics in, for example, but not limited to, the legal subject area: the legal roles of each word, which is a text element 61 (correlated with a separate actual SU or part of an actual SU), in the linguistic sentence 51, 52, 53 from the fourth data structure 5. The legal role of the word is its legal position in the legal entities (legal objects) of the sentence, including, for example, but not limited to, a legal concept, a sign of a legal concept, a legal term, a subject of legal relations, an object of legal relations, an element of the content of legal relations, a hypothesis, a disposition, a sanction (a structural part of a legal norm), a legal norm. The legal role of a word in simple legal objects, such as the legal concept and the legal attribute, does not depend on the legal structure of the, being a tag (index) that indicates what a given word means in a given simple legal object. For example, the word “law” is always an object of legal relations, while the word “federal” is an attribute of the object of legal relations. The legal role of a word in more complex (composite) legal objects (for example, hypotheses, dispositions or sanctions) depends on the formal model of the structural part of the legal norm, in relation to the elements (logical objects of the FMLSP) of which the logical role of the word can be established.

Preferably, but not limited to, the logical and subject features can be generated only if the logical and subject data arrays contain correlated objects (objects that can be matched). Taking into consideration, for example, but not limited to, the subject area of law, the possibility of matching correlated objects can be regarded not speculatively, but practically. The practicality of matching logical objects in a sentence with legal objects can be assessed based on the results of scientific research in this subject area. Open sources reliably show that legal scholars reasonably believe that, from the logical point of view, any legal norm is a proposition, while the legal and logical structured of a legal norm are reflected in a specific linguistic construct, where language functions as a legal and technical tool. In legal documents, any proposition is represented by a declarative sentence. In addition, but not limited to, the logical structure of a judgement correlates with the grammatical structure of a complex sentence. The meaning of the grammatical structure of the sentence coincides with that of the legal structure of the legal norm. Currently, the theory of the legal norm fully allows us to consider any legal norm as a proposition and confirms the fact that there are interrelations and unity of the legal norm, wherein legal, logical and grammatical structures are unified. Thus, the interrelationships of legal and logical structures are the basis for the interrelations (correlations) between the elements of legal and logical structures. In other words, logical objects of logical structures and legal objects of legal structures can be compared with each other. In addition, the result of such a comparison is the correlation between specific legal objects and specific logical objects. Such correlation is practically possible thanks to formal models (both legal and logical) that contain correlated objects. The priority formal model is the legal (subject) formal model (formal model of the structural part of a legal norm), because the number and type of objects (elements) of the legal (subject) formal model sets the level of detail and depth of structuring of the logical formal model (formal model of the logical structure of a proposition). The actual formal model of the basic structure of the subject area (FMBSSA) is set in advance and stored in the second user database (second UDB), which is, therefore, a database of actual basic subject area objects (actual BSAOs) and FMBSSAs, including the table of correlations between actual BSAOs and actual logical objects (actual LOs).

Preferably, but not limited to, the first part of the linguistic, logical, and subject characteristics, i.e. language characteristics 613 and their meanings 6131, for said text elements 61 of each language sentence 51, 52, 53 from the fourth data structure 5 is formed in step 10071 through the first comprehensive analysis of each text element 61 of the language sentence 51, 52, 53 from the fourth data structure 5, which is an analysis of said text elements 61, for example, but not limited to, based on their locations in the structure of a sentence, their meanings, types, conceivable images and connections to other text elements in the sentence, as well as using information from the first UDB about the actual SUs. Preferably, based on the results of the first comprehensive analysis, the linguistic characteristics 613 are formed and input into DBLLSF 30 in the form of a list of linguistic characteristics 613 with meanings of these characteristics 6131 in step 10074. For example, but not limited to, one of the language characteristics 613 may be the “syntactic role” of said text elements 61 of the language sentence 51, 52, 53 from the fourth data structure 5, matching the meaning of the given language characteristic, for example, “subject”; or it may also be the “syntactic role” of the actual SU that may comprise either a single text element 61 of the linguistic sentence 51, 52, 53 from the fourth data structure 5, or grouped said text elements 61, matching the meaning of the given language characteristic, for example, “adverbial modifier of place”. Such analysis can be carried out in any way known from prior art and, accordingly, is not described any further. For example, but not limited to, such complex analysis can be performed either traditionally, by a language specialist, or using a software algorithm of a language (syntactic) processor, or through a traditional programming approach based on encoded immutable rules (a rule-based system). In addition, given enough samples, such analysis can be performed using a statistical processor (neural networks, AI systems) using neural network/AI training technologies.

Preferably, but no limited to, the second part of the linguistic-logical-subject features of said text elements 61 of language sentences 51, 52, 53 from the fourth data structure 5, namely logical features 614 and their meanings 6141, is generated in step 10072 by means of a second comprehensive analysis of each of said text elements 61 of said language sentences 51, 52, 53 from the fourth the data structure 5, as well as each of the actual SUs, wherein, for example, but not limited, said text elements 61 (or several text elements 61 that make up the actual SU) are analyzed based on locations of said text elements 61 (or grouped text elements 61) in the sentence structure, their meanings, types, conceivable images and connections to other text elements in the sentence, as well as by analyzing the identified linguistic features 613 and their meanings 6131, using information from the first UDB about the actual SUs correlated with the actual LOs found in the FMLSP. Preferably, but not limited to, the logical characteristics 614 of said text elements 61 of the language sentence 51, 52, 53 from the fourth data structure 5 are formed based on the results of the second comprehensive analysis, and then input into DBLLSF 30 in the form of a list of logical characteristics 614 with meanings of these characteristics 6141 in step 10074. For example, but not limited to, one of the logical characteristics 614 of said text element 61 may be its “logical role” with the meaning of the logical characteristic “sign of the concept”, or one of the logical characteristics 614 of the group of said text elements 61 (actual SU) may be its “logical role” with meanings of the logical characteristic “the subject of proposition”. Such analysis can be carried out in any way known from prior art and, accordingly, is not described any further. For example, but not limited to, such complex analysis can be performed either traditionally, by a language specialist, or using a software algorithm of a language (syntactic) processor, or through a traditional programming approach based on encoded immutable rules (a rule-based system). In addition, given enough samples, such analysis can be performed using a statistical processor (neural networks, AI systems) using neural network/AI training technologies.

Preferably, but not limited to, the third part of the linguistic, logical, and subject characteristics, i.e. subject characteristics 615 and their meanings 6151, for said text elements 61 of each language sentence 51, 52, 53 of the fourth data structure 5 is formed in step 10073 through the third comprehensive analysis of each text element 61 of the linguistic sentence 51, 52, 53 from the fourth the data structure 5, as well as of each actual LO, wherein, for example, but not limited to, said text elements 61 (or several said text elements 61) that make up the actual LO are analyzed, based on the logical characteristics 614 and their meanings 6141, their relationships with other logical objects in the sentence, as well as information from the first UDB about actual LOs correlated with the subject area objects put into the FMBSSA, including the table of correlations between actual BSAOs and actual logical objects (actual LOs). Preferably, but not limited to, the subject characteristics 615 of said text elements 61 of the language sentence 51, 52, 53 from the fourth data structure 5 are formed based on the results of the third comprehensive analysis, and then input into the DBLLSF 30 in the form of a list of subject characteristics 615 with meanings of these characteristics 6151 in step 10074. For example, but not limited to, one of the subject characteristics 615 of said text element 61 in the subject area of law may be the “legal role” of said text element 61 with the meaning of this subject parameter 6151 of a “subject of legal relations”. Such analysis can be carried out in any way known from prior art and, accordingly, is not described any further. For example, but not limited to, such complex analysis can be performed either traditionally, by a language specialist, or using a software algorithm of a language (syntactic) processor, or through a traditional programming approach based on encoded immutable rules (a rule-based system). In addition, given enough samples, such analysis can be performed using a statistical processor (neural networks, AI systems) using neural network/AI training technologies.

Preferably, but not limited to, based on the identified first part of the linguistic, logical, and subject characteristics 613 of textual elements 61 of language sentences 51, 52, 53 from the fourth data structure 5 and their meanings 6131, the second part of the linguistic, logical, and subject characteristics 614 of textual elements 61 of language sentences 51, 52, 53 from the fourth data structure 5 and their meanings 6141, and the third part of the linguistic, logical, and subject characteristics 615 of textual elements 61 of language sentences 51, 52, 53 from the fourth data structure 5 and their meanings 6151, eventually, the database of linguistic-logical-subject features 20 is formed, which is the DBLLSF 30 of text elements 61 of language sentences 51, 52, 53 from the fourth data structure 5. In addition, the first part of the linguistic, logical, and subject characteristics 613 of said text elements 61 of language sentences 51, 52, 53 from the fourth data structure 5 and their meanings 6131 form unique language features of text elements 61 of language sentences 51, 52, 53 from the fourth data structure 5, the second part of the linguistic, logical, and subject characteristics 614 of said text elements 61 of language sentences 51, 52, 53 from the fourth data structure 5 and their meanings 6141 form unique logical features of text elements 61 of language sentences 51, 52, 53 from the fourth data structure 5, and the third part of the linguistic, logical, and subject characteristics 615 of said text elements 61 of language sentences 51, 52, 53 from the fourth data structure 5 and their meanings 6151 form unique subject features of text elements 61 of language sentences 51, 52, 53 from the fourth data structure 5.

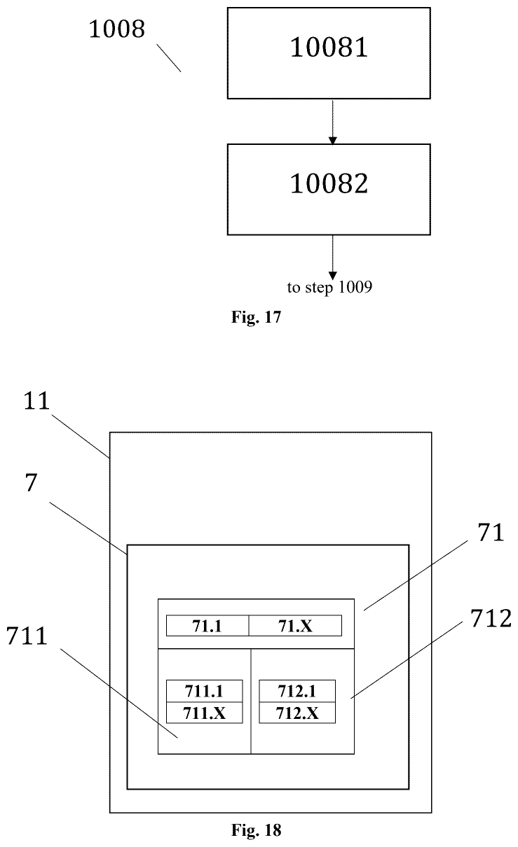

FIG. 17 illustrates an exemplary, non-limiting, overall scheme for the steps in step 1008 of generating the sixth data structure 7. Preferably, but not limited to, step 1008 further involves generating 10081 the elements 71 of the sixth data structure 7, which are simple judgement components 71 of corresponding language sentences 51, 52, 53 from the fourth data structure 5, as well as their identification data, which comprises the type 71.1, 71.x of each component 71, its meaning 711, and its index number 712 in corresponding language sentence 51, 52, 53 from the fourth data structure 5, wherein said elements are identified and generated based on the contents of the database 20 of linguistic-logical-subject features, the fifth data structure 6, and the first user database that contains the data of relevant syntactical units, relevant logical objects, and the relevant formal model of the logical structure of a judgement; and generating 10082 the sixth data structure 7 from the aforementioned simple judgement components 71, and their identification data, wherein said simple judgements are the same simple judgements in corresponding language sentences 51, 52, 53 from the fourth data structure 5.

FIG. 18 illustrates an exemplary, non-limiting, general diagram of a generated sixth data structure 7. Preferably, but not limited to, the sixth data structure 7 (sixth DS 7) contains elements 71, representing said components of simple judgements 71 of each simple judgement in each language sentence 51, 52, 53 from the fourth data structure 5 and their identification data, which at least have the form of 71.1, 71.X of said simple judgement components 71, meanings 711 of said simple judgement components 71, the index numbers 712 of said simple judgement components 71 in corresponding language sentence 51, 52, 53 from the fourth data structure 5, constituting such simple judgement components 71 in the language sentence 51, 52, 53 from the fourth data structure 5. Preferably, but not limited to, said components of simple judgements 71 of the language sentence 51, 52, 53 from the fourth data structure 5 are elements of a simple judgement. Preferably, according to the theory of logic, simple judgements are a set of structural elements of a simple judgement, with the help of which something about the subject of a judgement is asserted or refuted. In addition, preferably, the main structural elements of a simple judgement are the subject and the predicate. Preferably, according to the theory of logic, the subject of a simple judgement is a concept about which the given simple judgement is concerned. Preferably, the predicate of a simple judgement, according to the theory of logic, is what is asserted or refuted about the subject of a judgement. For example, but not limited to, the simple sentence “The authorized seller is obliged to transfer the goods to the buyer after payment” contains a “subject” of the simple judgement, which means “authorized seller”, as well as a “predicate” of the simple judgement, which means “is obliged to transfer the goods to the buyer after payment”. In addition, preferably, the structural elements of simple judgements consist of concepts that may have signs of concepts. For example, but not limited to, the “subject” of a simple judgement, which means “authorized seller” consists of the concept (seller) and the attribute of this concept (authorized). Preferably, but not limited to, for practical purposes related to the proposed transforming of a structured data array, i.e. the digitalized document 1, it is superfluous to identify simple judgements in language sentences 51, 52, 53, which have only two structural elements (“subject” and “predicate”), since the main purpose of logical formalization of language sentences 51, 52, 53 from the fourth data structure 5 is to form such formal objects, i.e. simple judgement components 71, which by themselves (based primarily on the type of a simple judgement component 71) explain the logical role of such formal objects (concepts, concepts with a sign, or grouped concepts and signs of concepts representing a logical image the element of a simple judgement) and their semantic function in a simple judgement, based on practical tasks that need to be solved by formalizing objects with relevant semantic functions. For example, but not limited to, in the subject area of law, it is necessary to formalize the legal norms contained in the proposals of legal documents. To achieve this, preferably, but not limited to, experts in the subject area of law create a formalized model of the structural part of a legal norm (FMSPLN), which is a formalized model of a hypothesis, disposition or sanction of a legal norm. Such FMSPLN contains elements that have unique semantic functions in the subject area of law, such as, for example, but not limited to, legal rules and legal facts (events and circumstances modifying the practical application of a legal rule). In addition, preferably, a legal rule consists of sub-elements (nested elements) representing the subject of legal relations, the object of legal relations and the content of legal relations, wherein, preferably, the content of legal relations sub-element also consists of sub-elements (nested elements), namely, a method of regulation, modifying objects and a definition (a defining expression that reveals the meaning of the defined concept or term or establishes the meaning of the concept or term, which means in practice a different name of the subject or object of legal relations, or the definition of the subject or object legal relations). Thus, preferably, based on the practical task and the aforementioned formal model formed to solve it, the number and types of elements of the aforementioned formal model (both sub-elements and elements that do not contain sub-elements) are determined. In addition, preferably, each element of such formalized model has unique semantic functions in the subject area, representing the actual elements of such formalized model. Preferably, such an actual formal model is a reference for the formation of the actual formal model of a simple judgement (formal model of the logical structure of a proposition), and in such a simple judgement, the structural element “predicate” should be divided into at least as many sub-elements, as there are actual elements in the formal model of the subject area minus one, since among the actual elements of a formalized model of subject area there always is one actual element that corresponds (correlates to) the structural element “subject”. In addition, preferably, such an actual formal model of a simple judgement (a formalized model of the logical construct of a judgement) contains actual elements of a simple judgement with actual semantic functions.

For example, but not limited to, Table 2 shows logical roles and semantic functions of structural simple judgement components (logical objects) in the sentence “The authorized seller is obliged to transfer the goods to the buyer after payment” without taking into account the solution to the practical task or the actual formal model of the subject area.

TABLE 2

| | | | Logical | Semantic |
|---|---|---|---|---|
| | | Meaning of a | role of a | function of a |
| | Structural | structural | structural | structural |
| | component | component | component | component |
| | of a simple | of a simple | of a simple | of a simple |
| No. | judgement | judgement | judgement | judgement |
| 1 | Subject | The authorized | Subject of a | What the |
| | | seller | judgement | proposition |
| | | | | is about |
| 2 | Predicate | Is obliged to | Predicate of a | What is |
| | | transfer the | judgement | affirmed or |
| | | goods to the | | negated about |
| | | buyer after | | the subject |
| | | payment | | of a judgement |

Therefore, preferably, this example shows that a simple judgement has at least two components (a subject and a predicate). In addition, preferably, the maximum number of components in a simple judgement solely depends on its actual formal model. For example, but not limited to, Table 3 shows logical roles and semantic functions of actual simple judgement components (logical objects) in the sentence “The authorized seller is obliged to transfer the goods to the buyer after payment” in view of solving a practical task and taking into account the actual formal model of the logical structure of a judgement and the actual formal model of the subject area.

TABLE 3

| | | Meaning of the | Logical role of the | |
|---|---|---|---|---|
| | Component of the | component of the | component of the | |
| | actual formal | actual formal | actual formal | Semantic function of the |
| | model of the simple | model of the simple | model of the simple | component of the actual formal |
| No. | judgement | judgement | judgement | model of the simple judgement |
| 1 | Subject | The authorized | Subject of a | The subject of legal relations |
| | | seller | judgement | (active) or the object of legal |
| | | | | relations in this component of |
| | | | | the legal norm, which is the |
| | | | | subject (object) of the legal |
| | | | | regulation |
| 2 | Link | — | Logical link | A link in the component of the |
| | | | | legal norm containing a |
| | | | | definition |
| 3 | Action of the | Is obliged to | The manner of | The manner of regulation in the |
| | predicate of a | transfer | modifying the | component of the legal norm |
| | judgement | | object | |
| 4 | Object of the | The goods | Affected object | The object of legal relations in |
| | predicate of a | | | the component of the legal |
| | judgement | | | norm, subjected to the legal |
| | | | | regulation |
| 5 | Subject of the | To the buyer | Countersubject (the | The subject of legal relations |
| | predicate of a | | subject associated | (passive), clarifying the legal |
| | judgement | | with the affected | regulation |
| | | | object) | |
| 6 | Complement of a | — | A different name of | Definition (a different name of |
| | judgement | | the subject of a | the subject or object of legal |
| | | | judgement | relations in the definition) |
| 7 | Additive object of | — | Additive object (the | Additional objects of legal |
| | the predicate of a | | object associated | relations that clarify the legal |
| | judgement | | with the affected | regulation |
| | | | object) | |
| 8 | Manner of the | After payment | Condition | The modifying circumstance of |
| | predicate of a | | | the legal fact |
| | judgement | | | |

Thus, preferably, said components of simple judgements 71 of the language sentence 51, 52, 53 from the fourth data structure 5 are all said components of simple judgements established in the actual formal model of the simple judgement (formal model of the logical structure of a judgement), wherein such an actual formal model is contained in the first user database (first UDB). Preferably, but not limited to, information about which text elements 61 of the language sentence 51, 52, 53 from the fourth data structure 5 constitute separate simple judgement components 71 of the linguistic sentence 51, 52, 53 from the fourth data structure 5 is contained in the database of linguistic-logical-subject features 30 (DBLLSF 30), formed in step 1007. In addition, preferably, the type of said simple judgement components 71 and the method of correlation (matching) of actual logical objects are also contained in DBLLSF 20.

Preferably, but not limited to, said components of simple judgements 71 (SPCs 71) can be of at least two types: first SPCs 71.1 and second SPCs 71.x. Preferably, but not limited to, the number of second SPCs 71.x corresponds to the number of elements of a simple judgement in a simple judgement model (the formalized model of the logical construct of a judgement). In addition, but not limited to, the first SPC 71.1 (element 1 in the actual formal model of the logical structure of a proposition) is always the subject. When identifying second SPCs 71.x, each identified SPC 71.x is assigned such an index x that corresponds to the index number of the element in the simple judgement presented in the actual formal model of the logical structure of a judgement. Preferably, but not limited to, meanings 711 of simple judgement components 71 of language sentences 51, 52, 53 from the fourth data structure are meanings 711 of simple judgement components 71 of all kinds (first SPC 71.1 and second SPCs 71.x.), which make up the simple judgement component 71. In addition, preferably, the meaning 711 of said components of simple judgements 71 refers to meanings 711.1 and 711.x of all said components of simple judgements 71.1 and 71.x identified in the language sentence 51, 52, 53. Preferably, but not limited to, the index number 712 of the simple judgement component 71 are the index numbers 712 of said components of simple judgements 71 in the language sentence 51, 52, 53 from the fourth data structure 5. In the sixth data structure 7, elements 71, for example, but not limited to, can be referred to as SPC1, SPC2, SPC3, SPCn, where n≥1 is the index number of the simple judgement component 71 in the language sentence 51, 52, 53 from the fourth data structure 5. In addition, but not limited to, the first simple judgement component 71 in the language sentence 51, 52, 53 is assigned the index number 1, the next one is assigned the index number 2, and so on until the last simple judgement component in the language sentence 51, 52, 53 is assigned the last index number. In addition, preferably, the sequence of said components of simple judgements 71 in the language sentence 51, 52, 53 is determined by the index number of the first text element 61, from which the linguistic construct 41 is formed, which is the data source for the formation of the language sentence 51, 52, 53. In other words, preferably, the sequence of components, based on the index number of its first text element, may be not in the form of 1-2-3-4 and so on, but, for example, but not limited to, in the form of 3-7-11-12-14-20 and so on, that is, based on the numbers of the first text elements 61 of said components of simple judgements 71 in the language sentence 51, 52, 53 from the fourth data structure 5. In addition, preferably, meanings 712 of said components of simple judgements 71 refer to meanings 712.1 and 712.x of all said components of simple judgements 71.1 and 71.x identified in the language sentence 51, 52, 53 from the fourth data structure 5. In addition, preferably, but not limited to, various types 71.1, 71.x of simple judgement components 71 of a language sentence 51, 52, 53 from the fourth data structure 5 are identified and formed based on the data from the database of linguistic-logical-subject features 30 (DBLLSF 30), containing both the information about the types of the elements of the simple judgement and the information about the content of individual elements of the simple judgement (that is, which textual elements 61 comprise each simple judgement component 71 in a language sentence 51, 52, 53 from the fourth data structure 5). Preferably, but not limited to, said components of simple judgements 71 of the language sentence 51, 52, 53 from the fourth data structure 5 are identified and formed in step 10081 by a comprehensive linguistic analysis of the elements 61 of the fifth data structure 6 and their identification data. Such a comprehensive analysis of said text elements 61 of the language sentence 51, 52, 53 from the fourth data structure 5 is performed using information about said text elements 61 from the DBLLSF 20, as well as based on data from the actual FMLSP. In addition, preferably, an actual formal model of the logical structure of a judgement contains at least two kinds of components: the first SPC 71.1 and the second SPC 71.x. Thus, preferably, the formalized model of the logical construct of a judgement is considered to be such a system of describing a simple judgement that has at least two of the aforementioned components. The purpose of the aforementioned comprehensive analysis is to identify in a language sentence all said components of simple judgements established by the formalized model of the logical construct of a judgement. Preferably, but not limited to, said components of simple judgements 71 of the sixth data structure 7 are identified and formed in step 10081 iteratively. The number of stages in step 10081 depends on the actual formal model of the logical structure of a judgement used. Preferably, but not limited to, said model contains a fixed number of types of elements of a simple judgement, and in accordance with this number of types, the number of stages of step 10081 is determined, since within one step it is possible to identify one type of element of a simple judgement and form only one type of a simple judgement component 71. In addition, but not limited to, since the formalized model of the logical construct of a judgement has to contain at least two components, the minimum number of steps will also be two. For example, but not limited to, Table 4 provides an example of the identification and formation of said components of simple judgements 71 in the language sentence “The authorized seller is obliged to transfer the goods to the buyer after payment” in accordance with the eight-element actual formal model of the logical structure of a judgement shown in Table 4.

TABLE 4

| | | Whether the | | | The index | |
|---|---|---|---|---|---|---|
| | | simple | | | number of the | |
| | | judgement | | | first text | |
| | Component of the | component | | | element 61 of | SPC 71 index |
| No. of | actual formal model | can be found | SPC | | the SPC 71 in | number in the |
| element/ | of the simple | in the | 71 | | the sentence | sentence 51, |
| step | judgement | sentence | type | SPC 71 meaning | 51, 52, or 53 | 52, or 53 |
| 1 | Subject | + | 71.1 | The authorized | 1 | 1 |
| | | | | seller | | |
| 2 | Link | − | 71.2 | — | — | — |
| 3 | Action of the | + | 71.3 | Is obliged to | 3 | 2 |
| | predicate of a | | | transfer | | |
| | judgement | | | | | |
| 4 | Object of the | + | 71.4 | The goods | 5 | 3 |
| | predicate of a | | | | | |
| | judgement | | | | | |
| 5 | Subject of the | + | 71.5 | To the buyer | 6 | 4 |
| | predicate of a | | | | | |
| | judgement | | | | | |
| 6 | Complement of a | − | 71.6 | — | — | — |
| | judgement | | | | | |
| 7 | Additive object of | − | 71.7 | — | — | — |
| | the predicate of a | | | | | |
| | judgement | | | | | |
| 8 | Manner of the | + | 71.8 | After payment | 7 | 5 |
| | predicate of a | | | | | |
| | judgement | | | | | |

Preferably, but not limited to, the naming of actual elements of a formalized model of a simple judgment, the identification of actual elements of the formalized model of a simple judgment in a language sentence, the identification of the types of SPCs 71, the identification of meanings of SPCs 71, if necessary, are carried out by sending a query to the database of linguistic-logical-subject features 30 (DBLLSF 30) of text elements 61 of language sentences 51, 52, 53 from the fourth data structure 5, which is formed in step 1007 and consists of identification data of text elements 61 of the linguistic sentence 51, 52, 53 from, the fourth data structure 5, to obtain the list of elements of the actual formal model of a simple judgement, as well as information on each text element 61 and in which elements of the simple judgement they are included. Preferably, but not limited to, SPCs 71 can be identified and generated in any way known from prior art that, accordingly, are not described any further. For example, but not limited to, such complex analysis can be performed either traditionally, by a language specialist, or using a software algorithm of a language (syntactic) processor, or through a traditional programming approach based on encoded immutable rules (a rule-based system). In addition, given enough samples, such analysis can be performed using a statistical processor (neural networks, AI systems) using neural network/AI training technologies.

Preferably, but not limited to, the sixth data structure 7 is generated in step 10082 by combining the elements 71 (SPCs 71) of the fifth data structure 7 and their identification data in a single data structure using methods and principles known from prior art and, accordingly, not described any further.

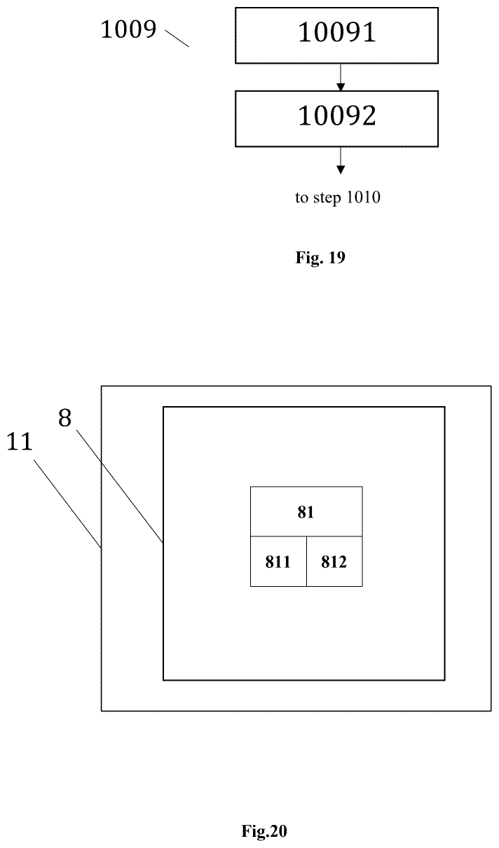

FIG. 19 illustrates an exemplary, non-limiting, overall scheme for the steps in step 1009 of generating the seventh data structure 8. Preferably, but not limited to, step 1009 further involves generating 10091, from said components of simple judgements 71 generated according to the actual formal model of the logical structure of a judgement, the elements 81 of the seventh data structure 8, which are simple judgements 81, as well as their identification data, which comprises meanings 811 of corresponding simple judgements and their index numbers 812 in corresponding language sentences 51, 52, 53 from the fourth data structure 5, based on the contents of the database of linguistic-logical-subject features, and the sixth data structure; and generating 10092 the seventh data structure 8 from the aforementioned simple judgements 81, and their identification data.

FIG. 20 illustrates an exemplary, non-limiting, general diagram of a generated seventh data structure 8. Preferably, but not limited to, the seventh data structure 8 (seventh DS 8) contains elements 81, which are simple judgements 81 of each linguistic sentence 51, 52, 53 from the fourth data structure 5, and the identification data of said simple judgements 81, which include, for example, but not limited to, meanings 811 of said simple judgements 81 and their index numbers 812 in corresponding linguistic sentence 51, 52, 53 from the fourth data structure 5.

Preferably, but not limited to, the simple judgements 81 of the language sentence 51, 52, 53 from the fourth data structure 5 are a combination of elements of a simple judgement. Preferably, such elements of a simple judgement 81, according to the theory of logic, represent the structural elements of a simple judgement, i.e., the subject and the predicate. In addition, preferably, the subject is the concept, about which something is asserted or refuted in a simple judgement, and the predicate is what is said in this simple judgement. In addition, preferably, from a practical point of view, the elements of a simple judgement 81 include the subject and a certain number of sub-elements (nested elements) of the predicate, wherein such a breakdown of the predicate into sub-elements is justified solely by practical purposes of solving an actual problem. The solution of actual problems determines the actual models of the logical structure of a judgement, which contain the actual elements of the simple judgement 81, on the basis of which, in step 1008, said components of simple judgements 71 of the language sentence 51, 52, 53 from the fourth data structure 5 are identified and formed. Preferably, but not limited to, a simple judgement 81 is a primary logical structure of thinking through which the idea is formed and transmitted that something (predicate of proposition) is asserted or refuted about the subject of proposition. Preferably, from a linguistic point of view, simple judgements 81 are simple sentences, or simplified simple sentences. In addition, preferably, various variants of simple sentences are possible, which can be considered simple judgements 81, such as, for example, but not limited to: simple sentences in their original, non-converted form, as well as simple sentences in a converted (simplified) form, for example, but not limited to: without participle or adverbial phrases, which themselves can be formed into simplified simple sentences that are modifying simple judgement; without homogeneous parts (i.e. formed into a number of simplified simple sentences); without inserts (without text in parentheses); without scary quotes (without text in quotation marks); without adverbial modifiers (conditions); and so on, including combinations of the types mentioned or not mentioned above. Preferably, but not limited to, simple judgements 81, from the point of view of syntactic connections between the words of a sentence containing said simple judgements 81, can be both main simple judgements and modifying simple judgements.

Preferably, but not limited to, the simple judgements 81 of the language sentence 51, 52, 53 from the fourth data structure 5 have identification data, which include the meaning 811 and the index number 812 of the simple judgement 81. Preferably, but not limited to, the meaning 811 of the simple judgement 81 is the set of meanings of said text elements 61 of all simple judgement components 71 that make up the simple judgement 81 of the language sentence 51, 52, 53 from the fourth data structure 5. Preferably, but not limited to, the index number 812 of the simple judgement 81 is the index number of the simple judgement 81 in the language sentence 51 from the fourth data structure. In the data structure, elements 81, for example, but not limited to, can be referred to as SP1, SP2, SP3, SPn, where n≥1 is the index number of the simple judgement component 81 in the language sentence 51, 52, 53 from the fourth data structure 5. Preferably, but not limited to, the simple judgements 81 of the language sentence 51 from the fourth data structure 5 are formed in step 10091, based on said components of simple judgements 71 in the language sentence 51, 52, 53 from the fourth data structure 5 formed in step 1008, by combining said simple judgement components 71 according to the actual formal model of the logical structure of a judgement and taking into account information from the database of linguistic-logical-subject features 30 of text elements 61 on the syntactic links between text elements 61 included in various simple judgement components 71. A non-limiting example of the formation of a simple judgement 81 of the language sentence 51, 52, 53 from the fourth data structure is given in Table 5 (the footnote under the symbol “*” means an ellipsis).

TABLE 5

| Simple judgement components 71 | | | | | | | | |
|---|---|---|---|---|---|---|---|---|
| | | SPC 71.1 | SPC 71.1 | SPC 71.1 | | SPC 71.1 | | |
| SPC 71.1 | SPC 71.1 | Action of the | Object of the | Subject of the | SPC 71.1 | Additive | SPC 71.1 | Simple |
| Subject | Link | predicate | predicate | predicate | Complement | object | Manner | judgement 81 |
| The buyer | — | Is obliged | The goods | To the | — | — | After | The buyer is |
| | | to transfer | | buyer | | | payment | obliged to |
| | | | | | | | | transfer the |
| | | | | | | | | goods to the |
| | | | | | | | | buyer after |
| | | | | | | | | payment |
| A violation | — | there was | — | — | — | — | In case . . . | In case there |
| | | | | | | | during | was a violation |
| | | | | | | | the sale | during the sale |
| The seller | is | — | — | — | A legal | — | — | The seller is a |
| | | | | | entity | | | legal entity |

Preferably, but not limited to, the meaning 811 of the simple judgement 81 of the language sentence 51, 52, 53 of the fourth data structure 5 is identified in step 10091 by associating the meaning 811 of the simple judgement 81 with meanings 711 of all simple judgement components 71 forming the given simple judgement 81. Preferably, but not limited to, the index numbers 812 of the simple judgement 81 of the language sentence 51, 52, 53 from the fourth data structure 5 are identified in step 10091 by comparing the index numbers of each simple judgement 81 of the language sentence 51, 52, 53 from the fourth data structure 5 with the index numbers of other simple judgement 81 of the same language sentence 51, 52, 53 from the fourth data structure 5. Preferably, but not limited to, such a simple judgement 81, which has a simple judgement component 71 with the lowest index number, will have the index number 1. If there are more than one such simple judgements 81, then the next simple judgement component 71 should be checked for such simple judgement 81, whose index number is the next in ascending order, wherein, but not limited to, such a simple judgement 81 is assigned the index number 1 as a result. Preferably, but not limited to, the following index numbers are assigned according to the same rules, wherein, but not limited to, simple judgements 81, which have already received their index numbers 812, no longer participate in said comparison. Also, elements 81 of the seventh data structure 8 can be identified and generated in any way known from prior art that, accordingly, are not described any further. For example, but not limited to, such complex analysis can be performed either traditionally, by a language specialist, or using a software algorithm of a language (syntactic) processor, or through a traditional programming approach based on encoded immutable rules (a rule-based system). In addition, given enough samples, such analysis can be performed using a statistical processor (neural networks, AI systems) using neural network/AI training technologies.

Preferably, but not limited to, the seventh data structure 8 is generated in step 10092 by combining the elements 81 of the fifth data structure 8 and their identification data in a single data structure using methods and principles known from prior art and, accordingly, not described any further.

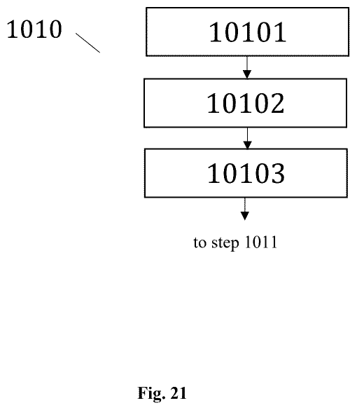

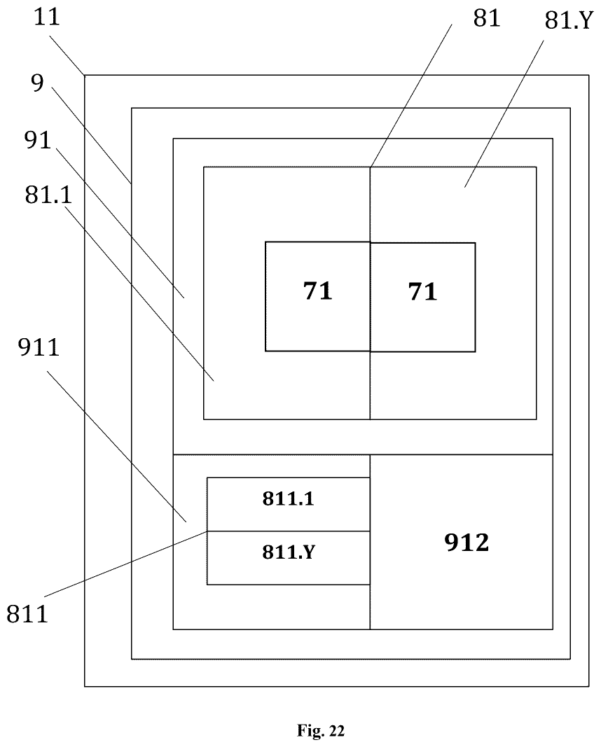

FIG. 21 illustrates an exemplary, non-limiting, overall scheme for the steps in step 1010 of generating the eighth data structure 9. Preferably, but not limited to, step 1010 further involves generating 10101 the elements 91 of the eighth data structure 9, which are resulting judgements 91 of corresponding language sentences 51, 52, 53 from the fourth data structure 5, as well as their identification data, which comprises meanings 911 of said resulting judgements 91 and their sequence 912 numbers in the eighth data structure 9, wherein said elements 91 are identified and generated based on the contents of the database of linguistic-logical-subject features 30, and the seventh data structure 8, as well as according to the actual formal model of the logical structure of a judgement; and generating 10102 the eighth data structure 9 from the aforementioned resulting judgements 91, and their identification data.

FIG. 22 illustrates an exemplary, non-limiting, general diagram of a generated eighth data structure 9. Preferably, but not limited to, the eighth data structure 9 (eighth DS 9) contains resulting judgements 91 of each language sentence 51, 52, 53 from the fourth data structure 5 and their identification data, which include, for example, but not limited to, meanings 911 of said resulting judgements 91 and their index numbers 912 in the eighth data structure 9. Preferably, but not limited to, said resulting judgements 91 of linguistic sentence 51, 52, 53 of the fourth data structure 5 represent, from the point of view of causality, conditioned and/or unconditional propositions. Unconditional propositions are assertions or refutations about the subject of a proposition that do not imply any conditions for the assertion or refutation. In other words, preferably, if a proposition has the sign of an unconditional proposition, then it has the form of a simple judgement. Preferably, such a single simple judgement as part of the resulting judgement 91 is the main simple judgement (rule). Preferably, conditioned judgments, on the contrary, imply a certain condition or set of conditions, under which assertions or refutations about the subject of a judgement are relevant or true. Preferably, any conditioned judgment has the form of a complex proposition, that is, grouped simple judgements, the elements of which are syntactically subordinate to each other. In addition, preferably, the simple judgement, the elements of which do not contain words that have the role of a syntactic child (a subordinate word in a pair of words with a subordinate syntactic connection), is the main simple judgement (rule), and the simple judgment, the elements of which contain a word or words that have the role of a syntactic child are a modifying simple judgement (conditionality).

Preferably, but not limited to, based on the presence of unconditional and conditional propositions, resulting judgements 91 may consist of simple judgements 81 of two kinds: first simple judgements 81.1 (FSPs 81.1), which include the main simple judgements (rules), and second simple judgements 81.Y (SSPs 81.Y, where Y≥2 is the sequence index of the SSP 81.Y as part of the resulting judgement 91), which include modifying simple judgements (conditionalities). In addition, both kinds of simple judgements 81 (FSP 81.1 and SSP 81.Y) are formed in step 1009 from said components of simple judgements 71. In addition, preferably, unconditional propositions contain only one FSP 81.1, while conditional propositions contain one FSP 81.1, but also additionally one or more SSPs 81.Y. Preferably, the sequence index Y of the SSP 81. Y as part of the resulting judgement 91 is determined by the index number 612 of the text element 61 in the element of the resulting judgement 91 of the SSP 81.Y, which has the role of a syntactic child. Preferably, the SSP 81. Y of the resulting judgement 91, which has the role of a syntactic child with the lowest index number 612 of the text element 61 among all the elements of the SSPs 81.Y of the resulting judgement 91 of one conditioned proposition receives index 2 (i.e., SSP 81.2). Preferably, the remaining unnumbered SSPs 81. Y of the same resulting judgement 91 are numbered further in the same way, receiving sequence indices Y equal to 3, 4, and so on. For example, but not limited to, it is possible to demonstrate the first and second simple judgements in the language sentence 51, 52, 53. For example, but not limited to, the language sentence “The police immediately comes to the aid of everyone who needs protection from criminal and other unlawful infringements” contains the following simple judgements 81: “The police immediately comes to the aid of everyone”; “Who needs protection from criminal infringements”; and “Who needs protection from other unlawful infringements”. Two complex propositions are formed from the simple judgements 81 mentioned above, wherein the syntactic parent, i.e., the main text element 61 in a pair of text elements 61 that are syntactically subordinate, is the text element 61 “to everyone”, and the syntactic child is the text element 61 “who”. In addition, respectively, the first simple judgement 81.1 (FSP 81.1.) is “The police immediately comes to the aid of everyone”, while the second simple judgements are SSP 81.2 “Who needs protection from criminal infringements” and SSP 81.3 “Who needs protection from other unlawful infringements”. Preferably, two resulting judgements 91 are obtained in this way, which are a complex proposition in terms of the composition of the elements. One resulting judgement 91, a complex one, consists of FSP 81.1 and SSP 81.2 (“The police immediately comes to the aid of everyone who needs protection from criminal infringements”), and another resulting judgements 91, which is also a complex one, consists of FSP 81.1 and SSP 81.3 (“The police immediately comes to the aid of everyone who needs protection from other unlawful infringements”).

Preferably, but not limited to, said resulting judgements 91 of a language sentence represent, from the point of view of interconnectedness of proposition rules, independent proposition rules and interdependent proposition rules, wherein independent proposition rules contain one FSP 81.1, and interdependent proposition rules contain two or more SSPs 81.1. Preferably, interdependent proposition rules are formed based on signs of dependence between simple judgements established in the requirements for the formation of propositions for the actual formal model of the logical structure of a judgement, that are contained in the second user database. For example, but not limited to, such requirements may relate to coordinate connections of the logical “And” type between individual FSPs 81.1. Such a relationship indicates, but not limited to, the interdependence of such proposition rules, or, in other words, the distortion of the meaning of a judgement when using separate proposition rules, which are interdependent. Preferably, the presence of interdependent rules can be demonstrated, for example, but not limited to, in said resulting judgements 91 of the following sentence: “Exceeding the allowed vehicle speed by more than 20 kmph, but not more than 40 kmph incurs imposition of an administrative fine in the amount of RUB 500.”. This sentence contains two simple judgements: “Exceeding the allowed vehicle speed by more than 20 kmph incurs imposition of an administrative fine in the amount of RUB 500”; and “Exceeding the allowed vehicle speed by not more than 40 kmph incurs imposition of an administrative fine in the amount of RUB 500”. In addition, but not limited to, the use of a linguistic tool that defines the boundaries of something (“from . . . to”; “more . . . , but not more”; “less . . . , but not less”; “from . . . to”; and so on) indicates at the interconnectedness and continuity of the formed simple judgements based on the logical “And”. Preferably, therefore, the two simple judgements indicated in the example above are interdependent propositions, representing, from the point of view of resulting judgements 91, a single resulting judgement 91. Also, for example, but not limited to, the presence of a coordinate connection of the type of logical “And” FSPs 81.1. can be demonstrated by an adverbial phrase, which is a syntactic child of a word from the FSP 81.1. For example, in the sentence “The driver must drive the vehicle at a speed not exceeding the set limit, taking into account traffic intensity.”, three simple judgements 81 can be identified: 1) “The driver must drive the vehicle at a speed”; 2) “The driver taking into account traffic intensity”; 3) “Speed not exceeding the set limit”. In addition, preferably, the simple judgements “The driver must drive the vehicle at a speed” and “The driver taking into account traffic intensity” are interdependent propositions; while the simple judgement “Speed not exceeding the set limit” is a condition for the simple judgement “The driver must drive the vehicle at a speed”.

Preferably, but not limited to, the meaning 911 of the resulting judgement 91 is meanings 811 of simple judgements 81, from which the resulting judgement 91 is formed. In addition, meanings 811 of simple judgements 81 are the meaning 811.1 of the first simple judgement (FSP 81.1.) and meanings 811.Y of second simple judgements (SSPs 81.Y), from which the resulting judgement 91 is formed. Preferably, but not limited to, the index number 912 of the resulting judgement 91 is the index number of the resulting judgement 91 in the eighth data structure 9. In the data structure, said resulting judgements 91, for example, but not limited to, can be referred to as RP1, RP2, RP3, RPn, where n≥1 is the index number of the element 91 in the eighth data structure 9. Preferably, but not limited to, index numbers 912 are assigned to said resulting judgements 91 of the language sentence 51, 52, 53 from the fourth data structure 5 as follows: index number 1 is assigned to the resulting judgement 91, formed from the linguistic sentence 51, 52, 53 with the index number 1 and consisting of a simple judgement 81 with the index number 1. Preferably, if, in the linguistic sentence 51, 52, 53 with the index number 1, a simple judgement 81 with the index number 1 belongs to a conditioned proposition, then the index number 1 is assigned to such a resulting judgement 91, which has the lowest number of second simple judgements 81.Y with the lowest index number 811 of a simple judgement 81. Preferably, the index number 2 is assigned to such a resulting judgement 91, in which the SSPs 81.Y of the resulting judgement 91 have higher index numbers of the simple judgement 81 than in the resulting judgement 91 with the index number 1, or, if there are no such second simple judgements 81.Y, then to such a resulting judgement 91, in which the FSPs 81.1 of the resulting judgement 91 have higher index numbers of the simple judgement 81 than in the resulting judgement 91 with the index number 1. Preferably, the same rule applies to determining the index numbers 912 of all the remaining elements 91 of the eighth data structure 9. Preferably, but not limited to, in case when FSP 81.1 of the resulting judgement 91 is grouped interrelated proposition rules, then the numbering of individual simple judgements included in the group of interrelated proposition rules is not performed, since these simple judgements already have unique index numbers, like the simple judgement 81.

Preferably, but not limited to, resulting judgements 91 of the eighth data structure 9 are identified and formed in step 10101 iteratively. In the first stage of step 10101, the rules of resulting judgements 91 (first simple judgements 81.1) are identified. In the second stage of step 10101, the conditionalities of said resulting judgements 91 (second simple judgements 81.Y) are identified for the identified rules of said resulting judgements 91. In the third stage of step 10101, the identified rules of resulting judgements 91 and the conditionalities of resulting judgements 91 are combined to form resulting judgements 91. Preferably, but not limited to, the rules of resulting judgements 91 (first simple judgements 81.1) are identified in the first stage of step 10101 through the third comprehensive analysis of the elements 81 of the seventh data structure 8, i.e., simple judgements 81 and their identification data. Such an analysis of simple judgements 81 is performed using information about text elements 61 and using information from the formed DBLLSF 20, as well as taking into account the requirements for a simple judgement 81, being a simple judgement of the first kind, i.e., a simple judgement that does not contain text elements that are syntactic children. Preferably, the purpose of the aforementioned third comprehensive analysis is to identify among the elements 81 of the seventh data structure 8 such simple judgements 81 that meet the requirements for the first simple judgement 81.1. Preferably, but not limited to, the conditionalities of said resulting judgements 91 (second simple judgements 81.Y) are identified in the second stage of step 10101 through the fourth comprehensive analysis of the elements 81 of the seventh data structure 8, i.e., simple judgements 81 and their identification data. Preferably, but not limited to, such an analysis of simple judgements 81 is performed using information about text elements 61 and using information from the formed DBLLSF 20, as well as taking into account the requirements for a simple judgement 81, being a simple judgement of the second kind, i.e. a simple judgement that contain text elements that are syntactic children. Preferably, the purpose of the aforementioned fourth comprehensive analysis is to identify for each identified first simple judgement 81.1 among the elements 81 of the seventh data structure 8 such simple judgements 81 that meet the requirements for the second simple judgement 81.Y. Preferably, but not limited to, the identified rules of resulting judgements 91 (first simple judgements 81.1) and the conditionalities of resulting judgements 91 (second simple judgements 81.Y) are combined to form resulting judgements 91 in the third stage of step 10101 through the fifth comprehensive analysis of the identified rules of resulting judgements 91 and the conditionalities of resulting judgements 91 and their identification data. Preferably, but not limited to, such an analysis is performed using information about text elements 61 and using information from the formed DBLLSF 20, as well as taking into account the requirements for assembling resulting judgements 91 from the first and second simple judgements. Preferably, the purpose of the aforementioned fifth comprehensive analysis is to identify and form elements 91 of the eighth data structure 9. For example, but not limited to, the requirements for the formation of resulting judgements 91 from first and second simple judgements contain at least the following conditions: if for the first simple judgement 81.1 no second simple judgement 81. Y was identified, then the resulting judgement 91 is formed from only one simple judgement 81, which is FSP 81.1; if for the first simple judgement 81.1 one second simple judgement 81.Y was identified, then the resulting judgement 91 is formed from two simple judgements 81, which are FSP 81.1 and SSP 81.Y; if for the first simple judgement 81.1 more than one second simple judgements 81. Y were identified, then in order to form the resulting judgement 91, syntactic subordinations between the identified second simple judgements 81.Y have to be identified, and after that the resulting judgement 91 is formed from the first simple judgement 81.1 and second simple judgements, which are syntactically subordinate to it. As a result, but not limited to, one of three variants of the formation of the resulting judgement 91 can be implemented: 1) in case all identified second simple judgements 81.Y are syntactically subordinate to each other, one element 91 will be formed from simple judgements 81, namely from FSP 81.1 and all SSPs 81.Y, arranged as a sequence of subordinate syntactical relations in accordance with the index numbers of index Y; 2) in case all identified second simple judgements 81. Y do not have a continuous syntactic subordination, then as many elements 91 will be formed from SSPs 81.Y, as there are second simple judgements 81.Y that share syntactic children; 3) in case some identified second simple judgements 81.Y have a continuous syntactic subordination and some identified second simple judgements 81.Y do not, then as many elements 91 will be formed, as there will be according to the first and the second variants above. For example, but not limited to, the following sentence can be considered: “The police are obliged to provide every citizen with the opportunity to get acquainted with the documents and materials that directly affect his/her rights and freedoms unless stated otherwise by federal law”. The following simple judgements 81 (SP 81) are formed from the sentence under consideration, wherein individual text elements 61 (words) are labeled according to their syntactic roles (SPn is the syntactic parent and SCn is the syntactic child, where n≥1 is the index number of the syntactic parent or syntactic child in the exemplary sentence), defining the syntactic subordinate relationships between the simple judgements of the sentence under consideration (see Table 6):

TABLE 6

| SP 81 | |
|---|---|
| No. | Simple judgements |
| 1 | The police are obliged to provide every citizen with the |
| | opportunity to get acquainted (SP1) with the documents (SP2) |
| 2 | The police are obliged to provide every citizen with the |
| | opportunity to get acquainted (SP1) with the materials (SP3) |
| 3 | The documents (SP2) that directly affect his/her rights |
| 4 | The documents (SP2) that directly affect his/her freedoms |
| 5 | The materials (SP3) that directly affect his/her rights |
| 6 | The materials (SP3) that directly affect his/her freedoms |
| 7 | Unless stated otherwise (SP1) by federal law |

At the first stage of step 10101, the first simple judgements 81.1 (FSP 81.1) have been identified (see Table 7):

TABLE 7

| FSP 81.1 | |
|---|---|
| No. | First simple judgements |
| 1 | The police are obliged to provide every citizen with the |
| | opportunity to get acquainted (SP1) with the documents (SP2) |
| 2 | The police are obliged to provide every citizen with the |
| | opportunity to get acquainted (SP1) with the materials (SP3) |

In the second stage of step 10101, all the second simple judgements 81.Y (SSPs 81.Y) syntactically subordinated to the identified first simple judgements 81.1 have been identified (see Table 8):

TABLE 8

| FSP 81.1 | First simple | | SSP 81.Y | | Second simple |
|---|---|---|---|---|---|
| No. | judgements | | No. | | judgements |
| 1 | 81.1 | The police are | 7 | 81.2 | Unless stated |
| | | obliged to provide | | | otherwise (SP1) by |
| | | every citizen with | | | federal law |
| | | the opportunity to | 3 | 81.3 | The documents (SP2) |
| | | get acquainted | | | that directly affect |
| | | (SP1) with the | | | his/her rights |
| | | documents (SP2) | 4 | 81.4 | The documents (SP2) |
| | | | | | that directly affect |
| | | | | | his/her freedoms |
| 2 | 81.1 | The police are | 7 | 81.2 | Unless stated |
| | | obliged to provide | | | otherwise (SP1) by |
| | | every citizen with | | | federal law |
| | | the opportunity to | 5 | 81.5 | The materials (SP3) |
| | | get acquainted | | | that directly affect |
| | | (SP1) with the | | | his/her rights |
| | | materials (SP3) | 6 | 81.6 | The materials (SP3) |
| | | | | | that directly affect |
| | | | | | his/her freedoms |

In the third stage of step 10101, a variant of the formation of a resulting judgement 91 based on each first simple judgement 81.1 is established for the formation of resulting judgements 91. For both of the first simple judgements 81.1, it was found that, firstly, all the second simple judgements 81.Y are not syntactically subordinate to each other, and, secondly, two second simple judgements (SSP 81.3 and SSP 81.4 for FSP 81.1 with the index number 1; and SSP 81.5 and SSP 81.6 for FSP 81.1 with the index number 2) have one syntactic child: SC2 in SSP 81.3 and SSP 81.4 for FSP 81.1 with the index number 1; and SC3 in SSP 81.5 and SSP 81.6 for FSP 81.1 with the index number 2. Therefore, two resulting judgements 91 (RS 91) are generated for each simple judgement 81.1 with index numbers 1 and 2 (see Table 9):

TABLE 9

| RS 91 | First simple | | SSP 81.Y | | Second simple |
|---|---|---|---|---|---|
| No. | judgements | | No. | | judgements |
| 1 | 81.1 | The police are | 7 | 81.2 | Unless stated |
| | | obliged to provide | | | otherwise (SP1) by |
| | | every citizen with | | | federal law |
| | | the opportunity to | 3 | 81.3 | The documents (SP2) |
| | | get acquainted | | | that directly affect |
| | | (SP1) with the | | | his/her rights |
| | | documents (SP2) | | | |
| 2 | 81.1 | The police are | 7 | 81.2 | Unless stated |
| | | obliged to provide | | | otherwise (SP1) by |
| | | every citizen with | | | federal law |
| | | the opportunity to | 4 | 81.4 | The documents (SP2) |
| | | get acquainted | | | that directly affect |
| | | (SP1) with the | | | his/her freedoms |
| | | documents (SP2) | | | |
| 3 | 81.1 | The police are | 7 | 81.2 | Unless stated |
| | | obliged to provide | | | otherwise (SP1) by |
| | | every citizen with | | | federal law |
| | | the opportunity to | 5 | 81.5 | The materials (SP3) |
| | | get acquainted | | | that directly affect |
| | | (SP1) with the | | | his/her rights |
| | | materials (SP3) | | | |
| 4 | 81.1 | The police are | 7 | 81.2 | Unless stated |
| | | obliged to provide | | | otherwise (SP1) by |
| | | every citizen with | | | federal law |
| | | the opportunity to | 6 | 81.6 | The materials (SP3) |
| | | get acquainted | | | that directly affect |
| | | (SP1) with the | | | his/her freedoms |
| | | materials (SP3) | | | |

Preferably, elements 91 of the eighth data structure 9 can be identified and generated in any way known from prior art that, accordingly, are not described any further. For example, but not limited to, such complex analysis can be performed either traditionally, by a language specialist, or using a software algorithm of a language (syntactic) processor, or through a traditional programming approach based on encoded immutable rules (a rule-based system). In addition, given enough samples, such analysis can be performed using a statistical processor (neural networks, AI systems) using neural network/AI training technologies.

Preferably, but not limited to, the eighth data structure 9 is generated in step 10102 by combining the elements 91 of the fifth data structure 9 of the SDA and their identification data in a single data structure using methods and principles known from prior art and, accordingly, not described any further.

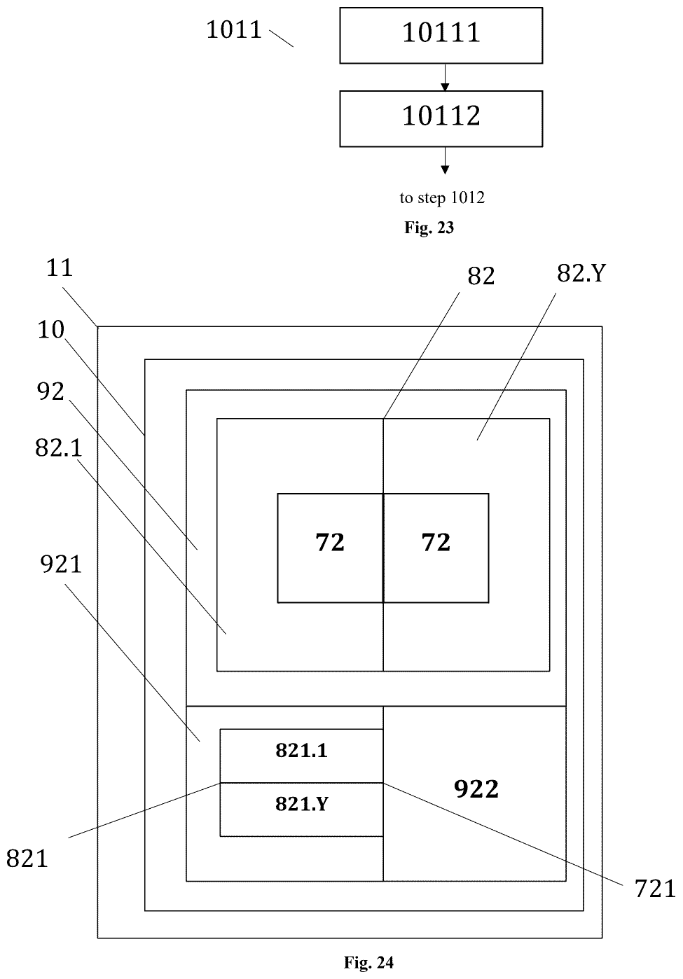

FIG. 23 illustrates an exemplary, non-limiting, overall scheme for the steps in step 1011 of generating the ninth data structure 10. Preferably, but not limited to, step 1011 further involves generating 10111 the elements 92 of the ninth data structure 10, which are basic structures 92 of the subject area, as well as their identification data, which comprises meanings 921 of said basic constructs 92 and their index numbers 922 in the ninth data structure 10, wherein said elements 92 are identified and generated based on the contents of the database of linguistic-logical-subject features 30, the second user database, the sixth data structure 7, the seventh data structure 8, and the eighth data structure 9, as well as according to the actual formal model of the basic structure of the subject area; and generating 10112 the ninth data structure 10 from the aforementioned basic constructs of subject area 92, and their identification data.

FIG. 24 illustrates an exemplary, non-limiting, general diagram of a generated ninth data structure 10. Preferably, but not limited to, the ninth data structure 10 (ninth DS 10) contains basic constructs of subject area 92 (BSSAs 92) of each language sentence 51, 52, 53 from the fourth data structure 5 and their identification data, which include, for example, but not limited to, meanings 921 of said BSSAs 92 and their index numbers 922 in the ninth data structure 10. Preferably, but not limited to, said basic constructs of subject area 92 of the language sentence 51, 52, 53 from the fourth data structure 5 represent, from a logical point of view, resulting judgements In other words, the eighth DS 9, containing elements 91, which are said resulting judgements 91, is an exclusively logical structure regardless of the subject area, while the ninth DS 10, containing elements 92, which are said basic constructs of subject area 92, is a logical structure of the subject area. In addition, preferably, both the exclusively logical structure, regardless of the subject area, and the logical structure of the subject area, from a logical point of view, consist of conditional and/or unconditional propositions. Preferably, viewed logically, the difference between an exclusively logical structure regardless of subject area and a logical structure that belongs to a subject area consists in the fact that said components of simple judgements in an exclusively logical construction regardless of subject area are SPCs 71 that contain logical objects established in the actual FMLSP, while said components of simple judgements in a logical structure that belongs to a subject area are BSSCs 72 that contain basic subject area objects established in the actual FMBSSA. In addition, the elements 71 in the FMLSP may be identical to the elements 72 in the FMBSSA or not. The rules for transforming elements 71 into elements 72 are described in the table of correlations between logical and subject area objects contained in the second user database. In addition, according to the same rules, by which first simple judgements 81.1 and second simple judgements 81 are formed from said components of simple judgements 71.Y exclusively by a logical structure regardless of the subject area, first simple judgements 82.1 of the logical construction of the subject area (first basic subject structures 82.1) and second simple judgements 82. Y of the logical structure of the subject area (second basic subject structures 82.Y) are formed from the components of the basic subject structure 72. In addition, the first basic subject area structure 82.1 and second basic subject area structures 82. Y are the basic subject area structures 82 of corresponding BSSAs 92.

Preferably, but not limited to, the basic structure of the subject area 92 is formed from the first basic subject area structure 82.1 and second basic subject area structures 82.Y, which is equivalent to the resulting judgement 91 in terms of the composition and content of simple judgements contained in the resulting judgement 91, which is done in the same way as when forming the resulting judgement 91 from the first simple judgements 81.1 and the second simple judgements 81.Y, the process of which is described in detail with reference to step 1010.

Preferably, but not limited to, said basic constructs of subject area 92 of the language sentence 51, 52, 53 from the fourth data structure 5, consisting of two types of elements (elements 82.1 and elements 82.Y) have the identification data of BSSAs 92: for example, but not limited to, meanings 921 of BSSAs, consisting of meanings 821.1 of elements 82.1 and meanings 821.Y of elements 82.Y, and the index number 922 of BSSA 92 in the ninth data structure 10.

Preferably, but not limited to, meanings 921 of BSSAs 92 are meanings 821 of basic subject area structures 82, from which the given BSSA 92 is formed. In addition, meanings 821 of basic subject area structures 82 are corresponding meanings 821.1 of the first basic subject area structure 82.1 and meanings 821.Y of second basic subject area structures 82. Y, from which the given BSSA 92 is formed.

Preferably, but not limited to, the index numbers 922 of BSSA 92 are the index numbers of BSSA 92 in the ninth data structure 10. In the data structure, for example, but not limited to, BSSAs 92 can be referred to as BSSA1, BSSA2, BSSA3, BSSAn, where n≥1 is the index number of the BSSA 92 in the ninth data structure 10. In addition, preferably, the index numbering of elements 92 in the ninth data structure 10 fully corresponds to the index numbering of elements 91 in the eighth data structure 9.

Preferably, but not limited to, the elements 92 of the ninth data structure 10 are identified and formed in step 10111 iteratively. At the first stage of step 10111, the basic subject area structure components 72 (BSSCs 72) are identified and formed from the elements of the SPCs71 of the sixth data structure 7. In the second stage of step 10111, the basic subject area structures 82 are formed from the elements of the BSSC 72. In the third stage of step 10111, first basic subject area structures 82.1 are identified and second basic subject area structures 82. Y are identified. In the fourth stage of step 10111, the identified first basic subject area structures 82.1 and the second basic subject area structures 82. Y are combined to form the BSSA 92 of the ninth data structure 10.

Preferably, but not limited to, the BSSCs 72 are identified and formed in the first stage of step 10111 based on data from the table of correlations between actual basic subject area objects (actual BSAOs) and actual logical objects (actual LOs) contained in the second user database (second UDB). In this case, the logical objects are SPCs 71, and the basic subject objects are BSSCs 72. Preferably, but not limited to, in terms of composition, the BSSC 72 elements may represent one or more SPCs 71, wherein, the exact composition of each BSSC 72 of a unique name is established with the help of the table of correlations between actual BSAOs and actual LOs. Preferably, but not limited to, basic subject area structures 82 are formed in the second stage of step 10111 from the BSSCs 72 in the same way as simple judgements 81 are formed from said components of simple judgements 71, which is described in detail with reference to step 1009. Preferably, but not limited to, first basic subject area structures 82.1 and second basic subject area structures 82. Y are identified in the third stage of step 10111 similarly to the identification of the rules of resulting judgements 91 (first simple judgements 81.1) and the conditionalities of resulting judgements 91 (second simple judgements 81.Y), which is described in detail with reference to step 1010.

Preferably, but not limited to, the identified first basic subject area structures 82.1 and the second basic subject area structures 82.Y are combined to form the basic subject area structures 92 and their identification data in the fourth stage of step 10111 in the same way as said resulting judgements 91 and their identification data are formed, which is described in detail with reference to step 1010.

For example, but not limited to, for the subject area of law, a proposition can be correlated with the basic subject area structure “structural part of a legal norm”, namely, for example, but not limited to, with a disposition (a rule that must be observed), a sanction (a rule that defines responsibility for violation of the rules) or a hypothesis (the conditionality of a rule reflecting some kind of preliminary action, situation or condition). These legal objects—hypothesis, disposition, sanction—can be found also in simple sentences of normative acts. In order to transform a proposition in the subject area of law, it is necessary to create a formalized model of the basic construct of subject area—in this case, the formalized model of the structural part of the legal norm (FMSPLN). A professional discussion may result in a number of different FMSPLNs. To generate the ninth data structure 10 of the SDA, it is necessary to create an actual FMSPLN, as well as a table of correlations between the elements of the actual formal model of the logical structure of a judgement (FMLSP) and the elements of the actual formal model of the structural part of the legal norm (FMSPLN). In addition, but not limited to, it must be obvious to persons skilled in the art that there is a rigid connection between a logical simple judgement and a part of a legal norm (hypothesis, disposition, sanction) which, for example, but not limited to, is demonstrated in the following examples in view of a formalized model of the logical construct of a judgement, the formalized model of structural parts of the legal norm, and the table of correlations, formed solely for example purposes. For example, but not limited to, let's consider the following sentence from a legal document, the Federal Law on Police: When contacting a citizen, in the case any measures restricting his/her rights and freedoms are taken, a police officer is obliged to explain to him/her the reasons and grounds for these measures, as well as his/her rights and obligations arising in this regard. For example, but not limited to, the actual formal model of the logical structure of a judgement may contain the following simple judgement components 71 (see Table 10):

TABLE 10
Simple judgement components 71

| | Predicate of a judgement (P) | | | | | |
|---|---|---|---|---|---|---|
| Subject of a | | | Subject of | | | |
| judgement | Action | Object | the predicate | Complement | Additive | Manners |
| SPC1 | SPC2 | SPC3 | SPC4 | SPC5 | SPC6 | SPC7 |

For example, but not limited to, the actual formal model of the structural part of the legal norm may contain the following components, i.e., basic subject structure components 72 (BSSC 72) (see Tables 11 and 12):

TABLE 11
Components of the first part of the formal model
of the structural part of the legal norm (BSSC 72)
Legal rule

| Subjects of legal relations | | Object of | Legal relations content | | |
|---|---|---|---|---|---|
| A(ctive) | A(ctive)/P(assive) | legal | Regulation | Modifying | Defi- |
| subject | subject | relations | method | objects | nition |
| BSSC1 | BSSC2 | BSSC3 | BSSC4 | BSSC5 | BSSC6 |

TABLE 12
Components of the second part of the formal model
of the structural part of the legal norm (BSSC 72)
Modifying legal facts

| | Modifying event (ME) | | | | | | |
|---|---|---|---|---|---|---|---|
| | | AE predicate | | | | | |
| Modifying | AE | AE | AE | AE | AE | AE | AE |
| circumstances | subject | action | object | subject | complement | additive | manner |
| BSSC7 | BSSC8 | BSSC9 | BSSC10 | BSSC11 | BSSC12 | BSSC13 | BSSC14 |

For example, but not limited to, the eighth DS 9 containing said resulting judgements 91 of the sentence under consideration has been formed in step 1010 (see Table 13);

TABLE 13

| | | | Simple judgement components 71 | | | | | | |
|---|---|---|---|---|---|---|---|---|---|
| | | | | Predicate of a judgement (P) | | | | | |
| | | | Subject | | | Subject | | | |
| No. | No. | | of a | | | of the | | | |
| RS | SP | SP | judgement | Action | Object | predicate | Complement | Additive | Manners |
| 91 | 81 | type | SPC1 | SPC2 | SPC3 | SPC4 | SPC5 | SPC6 | SPC7 |
| 1 | 2 | 3 | 4 | 5 | 6 | 7 | 8 | 9 | 10 |
| 1 | 1 | 81.1 | A police | Is obliged to | The reasons | To him/her | — | — | When contacting a |
| | | | officer | explain | for these | | | | citizen |
| | | | | | measures | | | | In the case any |
| | | | | | | | | | measures are taken |
| | 5 | 81.2 | Measures | Restricting | His/her rights | — | — | — | — |
| 2 | 2 | 81.1 | A police | Is obliged to | The grounds | To him/her | — | — | When contacting a |
| | | | officer | explain | for these | | | | citizen |
| | | | | | measures | | | | In the case any |
| | | | | | | | | | measures are taken |
| | 5 | 81.2 | Measures | Restricting | His/her rights | — | — | — | — |
| 3 | 3 | 81.1 | A police | Is obliged to | His/her rights | To him/her | — | — | When contacting a |
| | | | officer | explain | | | | | citizen |
| | | | | | | | | | In the case any |
| | | | | | | | | | measures are taken |
| | 5 | 81.2 | Measures | Restricting | His/her rights | — | — | — | — |
| | 7 | 81.4 | Rights | Arising | — | — | — | — | In this regard |
| 4 | 4 | 81.1 | A police | Is obliged to | His/her | To him/her | — | — | When contacting a |
| | | | officer | explain | obligations | | | | citizen |
| | | | | | | | | | In the case any |
| | | | | | | | | | measures are taken |
| | 5 | 81.2 | Measures | Restricting | His/her rights | | — | — | — |
| | 8 | 81.5 | Obligations | Arising | — | — | — | — | In this regard |
| 5 | 1 | 81.1 | A police | Is obliged to | The reasons | To him/her | — | — | When contacting a |
| | | | officer | explain | for these | | | | citizen |
| | | | | | measures | | | | In the case any |
| | | | | | | | | | measures are taken |
| | 6 | 81.3 | Measures | Restricting | His/her | — | — | — | — |
| | | | | | freedoms | | | | |
| 6 | 2 | 81.1 | A police | Is obliged to | The grounds | To him/her | — | — | When contacting a |
| | | | officer | explain | for these | | | | citizen |
| | | | | | measures | | | | In the case any |
| | | | | | | | | | measures are taken |
| | 6 | 81.3 | Measures | Restricting | His/her | — | — | — | — |
| | | | | | freedoms | | | | |
| 7 | 3 | 81.1 | A police | Is obliged to | His/her rights | To him/her | — | — | When contacting a |
| | | | officer | explain | | | | | citizen |
| | | | | | | | | | In the case any |
| | | | | | | | | | measures are taken |
| | 6 | 81.3 | Measures | Restricting | His/her | — | — | — | — |
| | | | | | freedoms | | | | |
| | 7 | 81.4 | Rights | Arising | — | — | — | — | In this regard |
| 8 | 4 | 81.1 | A police | Is obliged to | His/her | To him/her | — | — | When contacting a |
| | | | officer | explain | obligations | | | | citizen |
| | | | | | | | | | In the case any |
| | | | | | | | | | measures are taken |
| | 6 | 81.3 | Measures | Restricting | His/her | — | — | — | — |
| | | | | | freedoms | | | | |
| | 8 | 81.5 | Obligations | Arising | — | | — | — | In this regard |

For example, but not limited to, the tenth DS 10 has been generated in step 1011, which is a basic structure of the subject area of law, namely the formalized model of the structural part of the legal norm (see Tables 14 and 15):

TABLE 14

| | Components of the first part of the formal model of the structural part of the legal norm (BSSC 72) | | | | | |
|---|---|---|---|---|---|---|
| | Legal rule | | | | | |
| | Subjects of legal relations | | | | | |
| | | A(ctive)/ | Object | Legal relations content | | |
| | A(ctive) | P(assive) | of legal | Regulation | Modifying | |
| BSSA | subject | subject | relations | method | objects | Definition |
| 92 No. | BSSC1 | BSSC2 | BSSC3 | BSSC4 | BSSC5 | BSSC6 |
| 1 | 2 | 3 | 4 | 5 | 6 | 7 |
| 1 | a police officer | to him/her | the reasons for these | is obliged to | — | — |
| | | | measures | explain | | |
| | — | — | — | — | — | — |
| 2 | a police officer | to him/her | the grounds for these | is obliged to | — | — |
| | | | measures | explain | | |
| | — | — | — | — | — | — |
| 3 | a police officer | to him/her | his/her rights [1] | is obliged to | — | — |
| | | | | explain | | |
| | — | — | — | — | — | — |
| 4 | a police officer | to him/her | his/her obligations [1] | is obliged to | — | — |
| | | | | explain | | |
| | — | — | — | — | — | — |
| 5 | a police officer | to him/her | the reasons for these | is obliged to | — | — |
| | | | measures | explain | | |
| | — | — | — | — | — | — |
| 6 | a police officer | to him/her | the grounds for these | is obliged to | — | — |
| | | | measures | explain | | |
| | — | — | — | — | — | — |
| 7 | a police officer | to him/her | his/her rights [1] | is obliged to | — | — |
| | | | | explain | | |
| | — | — | — | — | — | — |
| 8 | a police officer | to him/her | his/her obligations [1] | is obliged to | — | — |
| | | | | explain | | |
| | — | — | — | — | — | — |

TABLE 15
Components of the second part of the formal model of the structural part of the legal norm (BSSC 72)

| | Modifying legal facts | | | | | | | |
|---|---|---|---|---|---|---|---|---|
| | | Modifying event (ME) | | | | | | |
| | | | AE predicate | | | | | |
| | Modifying | | AE | AE | AE | AE | AE | AE |
| SSA | circumstance | AE entity | action | object | subject | complement | additive | manner |
| 92 | BSSC7 | BSSC8 | BSSC9 | BSSC10 | BSSC11 | BSSC12 | BSSC13 | BSSC14 |
| S/N | 8 | 9 | 10 | 11 | 12 | 13 | 14 | 15 |

| | | | | | | |
|---|---|---|---|---|---|---|
| 1 | when contacting | measures | restricting | his/her | — | |
| | a citizen | [1] | | rights | | |
| | in the case any | | | | | |
| | measures [1] are | | | | | |
| | taken | | | | | |
| 2 | when contacting | measures | restricting | his/her | | |
| | a citizen | [1] | | rights | | |
| | in the case any | | | | | |
| | measures [1] are | | | | | |
| | taken | | | | | |
| 3 | when contacting | rights [1] | arising | | | in this regard |
| | a citizen | | | | | |
| | in the case any | measures | restricting | his/her | | |
| | measures [2] are | [2] | | rights | | |
| | taken | | | | | |
| 4 | when contacting | obligations | arising | | | in this regard |
| | a citizen | [1] | | | | |
| | in the case any | measures | restricting | his/her | | |
| | measures [2] are | [2] | | rights | | |
| | taken | | | | | |
| 5 | when contacting | measures | restricting | his/her | | |
| | a citizen | [1] | | freedoms | | |
| | in the case any | | | | | |
| | measures [1] are | | | | | |
| | taken | | | | | |
| 6 | when contacting | measures | restricting | his/her | | |
| | a citizen | [1] | | freedoms | | |
| | in the case any | | | | | |
| | measures [1] are | | | | | |
| | taken | | | | | |
| 7 | when contacting | rights [1] | arising | | | in this regard |
| | a citizen | | | | | |
| | in the case any | measures | restricting | his/her | | |
| | measures [2] are | [2] | | freedoms | | |
| | taken | | | | | |
| 8 | when contacting | obligations | arising | | | in this regard |
| | a citizen | [1] | | | | |
| | in the case any | measures | restricting | his/her | | |
| | measures [2] are | [2] | | freedoms | | |
| | taken | | | | | |

Preferably, but not limited to, elements 92 of the ninth data structure 10 can be identified and generated in any way known from prior art that, accordingly, are not described any further. For example, but not limited to, such identification and generation can be performed either traditionally, by a law specialist, or through a traditional programming approach based on encoded immutable rules (a rule-based system) using a software algorithm of a language (syntactic) processor. In addition, given enough samples, such analysis can be performed using a statistical processor (neural networks, AI systems) using neural network/AI training technologies.

Preferably, but not limited to, the ninth data structure 10 is generated in step 10112 by combining the elements 92 of the ninth data structure 10 and their identification data in a single data structure using methods and principles known from prior art and, accordingly, not described any further.

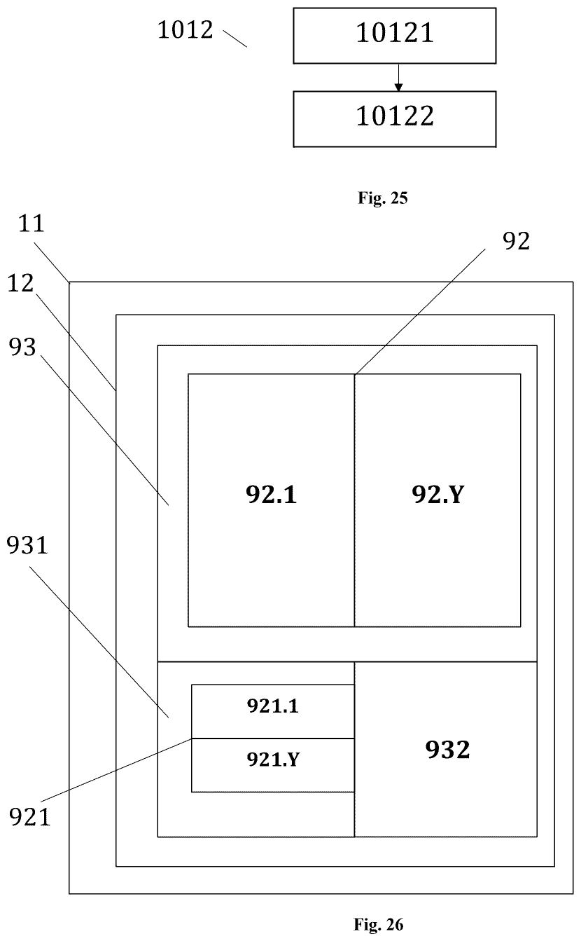

FIG. 25 illustrates an exemplary, non-limiting, overall scheme for the steps in step 1012 of generating the final data structure 12. Preferably, but not limited to, step 1012 further involves generating 10121 the elements 93 of the final data structure 12, which are target constructs 93 of the subject area, as well as their identification data, which comprises meanings 931 of said target constructs 93 and their index numbers 932 in the final data structure 12, wherein said elements are identified and generated based on the contents of the third user database and the ninth data structure 10, as well as according to the actual formal model of the target construct of the subject area; and generating 10122 the final data structure 12 from the aforementioned target constructs 93 of the subject area, and their identification data.

FIG. 26 illustrates an exemplary, non-limiting, general diagram of a generated final data structure 12. Preferably, but not limited to, the elements 93 of the final data structure 12 (final DS 12), representing the target constructs of subject area 93 (TSSA 93) of each of said language sentences 51, 52, 53 from the fourth data structure 5 and their identification data, which include, for example, but not limited to, meanings 931 of said elements 93 and their index numbers 932 in the final data structure 12.

Preferably, but not limited to, target constructs of subject area 93 (TSSA 93) of said language sentences 51, 52, and 53 from the fourth data structure 5 can be single-element, multi-element, or mixed. Preferably, single-element constructions are the elements 93 of the final data structure 12 that are identical to the elements 92 of the ninth data structure 10, i.e. to said basic constructs of subject area 92 (BSSA 92); in other words, the type (composition) of the target construct of the subject area 93 for a single-element structure coincides with the type (composition) of the basic structure of the subject area 92. In addition, preferably, all identified TSSAs 93 have identical unique functional designations.

Preferably, but not limited to, multi-element structures should contain at least two TSSAs 93 with different unique functional designations, fulfil the conditions, under which individual BSSAs 92 are identified as TSSAs 93 with different unique functional designations, and comply to the rules of combining the identified BSSAs 92 with different unique functional designations into a multi-element structure. Preferably, but not limited to, mixed structures imply that a TSSA 93 contains both single-element structures and multi-element structures.

Preferably, but not limited to, due to different possible structures of elements 93 (single-element, multi-element, mixed) described above, a target construct of the subject area 93 can consist BSSAs 92 of two types: the main BSSA 92.1 and additional BSSAs 92.Y; wherein single-element structures contain only a single main BSSA 92.1, and multi-element structures contain one main BSSA 92.1, but also additionally contain one or more additional BSSAs 92.Y, where Y≥2 is the index of the BSSA 92 of the unique name in the TSSA 93.

For example, but not limited to, it is possible to demonstrate main BSSAs 92.1 and additional BSSAs 92. Y in the legal subject area; wherein it should be clarified that in the legal subject area, a TSSA 93 may be, for example, but not limited to, a structure of a legal norm. Unlike the composition of the structural elements of a legal norm (hypothesis, disposition, sanction), the composition of the elements of a legal norm (structure of a legal norm) is a debatable issue in the legal community. There are many concepts concerning the composition of legal norms, among which the following main groups can be distinguished according to the structure (composition) of a legal norm: legal norms regulating legal relations in everyday life, which are two-element structures consisting of at least the “disposition” and “sanction” structural parts of the legal norm; legal norms establishing normative definitions for individual subjects or objects of legal relations, which are single-element structures consisting of at least the “disposition” structural part of the legal norm; legal norms establishing principles, guarantees, declarations, which are single-element structures consisting of at least the “disposition” structural part of the legal norm; legal norms having a one-element or two-element structure and containing a structural part of the legal norm justifying the disposition, wherein such a disposition is the result or consequence of meeting the rules and/or conditions established in other regulatory rules confirming the status of the disposition relevant (valid and permissible) for its application in a particular branch (institute, sub-institute) of law, on the basis of specific legal principles, guarantees and declarations, in specific legal circumstances, in specific territories, in a specific time period. Such other regulatory rules are an integral structural part of said dispositions-a hypothesis. In addition, the number of such hypotheses may not be limited to one, but represent a structure of hypotheses, among which the relevance of the disposition will be justified by not one, but several hypotheses. In addition, in such a structure of hypotheses, there may be not only hypotheses justifying the relevance of the disposition, but also hypotheses justifying the relevance of the hypotheses included in the structure of hypotheses. Therefore, preferably, but not limited to, a TSSA 93 includes elements 92.1 and 92. Y of the ninth data structure 10.

Preferably, but not limited to, the target constructs of subject area 93 of language sentences 51, 52, 53 from the fourth data structure 5, consisting of elements 92 of two types: 92.1 and 92.Y, have the identification data of TSSAs 93: for example, but not limited to, meanings 931 of TSSAs 93, consisting of meanings 921.1 and 921. Y of elements 92.1 and 92.Y, and the index numbers 932 of TSSAs 93, which are the index numbers 932 of TSSAs 93 in the final data structure 12.

Preferably, but not limited to, meanings of 931 of TSSAs 93 are meanings 921.1 and 921. Y of corresponding elements 92.1 and 92. Y of corresponding BSSA 92 of the ninth data structure 10, from which corresponding TSSA 93 is formed.

Preferably, but not limited to, the index numbers 932 of TSSAs 93 are the index numbers 932 of TSSAs 93 in the final data structure 12. In the TSSA 93 data structure, for example, but not limited to, each element 93 can be referred to as TSSA1, TSSA2, TSSA3, TSSAn, where n≥1 is the index number of the element of the TSSA 93 in the final data structure 12. Preferably, but not limited to, the index numbering of elements 93 in the array of target constructions of the subject area of language sentences 51, 52, 53 from the fourth data structure 5 is performed as follows: index number 1 is assigned to the TSSA 93, formed from a language sentence 51, 52, or 53 with index number 1, consisting of the BSSA 92 with index number 1. If the element 92 with index number 1 in the linguistic sentence 51, 52, or 53 with index number 1 refers to the additional BSSA 92 (92.Y), then index number 1 is assigned to such TSSA 93, which has the minimum number of BSSA 92.Y with a minimum index number. Index number 2 is assigned to such TSSA 93, in which the elements of BSSA 92. Y have higher index numbers than in the TSSA 93 with index number 1. If there are no such BSSAs 92. Y, then index number 2 is assigned such TSSA 93, in which the elements of BSSA 92.1 have a higher index number of the BSSA 92.1 than in the TSSA 93 with index number 1. Then, all elements 93 of the final data structure 12 of the SDA are assigned an index number in the same manner.

Preferably, but not limited to, the TSSA 93 of the final data structure is identified and formed in step 10121. At the first stage of step 10121, the main BSSAs 92.1 of the TSSA 93 are identified. At the second stage of step 10121, additional BSSAs 92.Y of the TSSA 93 are identified for the identified elements of the BSSA 92.1 of the multi-element structures of the TSSA 93. At the third stage of step 10121, the identified main BSSAs 92.1 of the TSSA 93 and additional BSSAs 92. Y of the TSSA 93 are combined (if any have been identified for corresponding BSSAs 92.1) in order to form a TSSA 93 of the language sentence 51, 52, 53 from the fourth data structure 5.

Preferably, but not limited to, the main BSSAs 92.1 of the TSSA 93 are identified at the first stage of step 10121 by means of the sixth comprehensive analysis of the elements of the ninth data structure 10 of the SDA, namely BSSAs 92 and their identification data. Such analysis of BSSAs 92 is performed using information about text elements 61 and information from the generated DBLLSF 30, as well as taking into account requirements for BSSAs 92, such as the main BSSAs 92.1, obtained, for example, but not limited to, from the data of the correlation table of said basic constructs of subject area of the ninth DS 10 and the actual components of the target constructs of subject area contained in a formalized model of the target construct of subject area (FMTCSA). The purpose of said sixth comprehensive analysis is to identify among the elements 92 of the ninth data structure 10 such BSSAs 92 that meet the requirements for the main BSSAs 92.1 of the TSSA 93.

Preferably, but not limited to, the additional BSSAs 92.1 of the TSSA 93 are identified at the second stage of step 10121 by means of the seven comprehensive analysis of the elements of the ninth data structure 10 of the SDA, namely BSSAs 92 and their identification data. Such analysis of BSSAs 92 is performed using information about text elements 61 and information from the generated DBLLSF 30, as well as taking into account requirements for BSSAs 92, such as the additional BSSAs 92.Y, obtained, for example, but not limited to, from the data of the correlation table of said basic constructs of subject area of the ninth DS 10 and the actual components of the target constructs of subject area contained in the FMTCSA. The purpose of said seventh comprehensive analysis is to identify among the elements of the ninth data structure 10 such BSSAs 92 that meet the requirements for the additional BSSAs 92. Y of the TSSA 93.

Preferably, but not limited to, the identified main BSSAs 92.1 of the TSSA 93 and additional BSSAs 92. Y of the TSSA 93 are combined to form the TSSA 93 at the third stage of step 10121 by means the eighth comprehensive analysis of the identified main BSSAs 92.1 of the TSSA 93 and additional BSSAs 92. Y of the TSSA 93 and their identification data. Such analysis is performed using information about text elements 61 and information from the formed DBLLSF 30, as well as taking into account the requirements for the formation of a TSSA 93 from the main BSSAs 92.1 and additional BSSAs 92. Y contained in the FMTCSA. The purpose of said eighth comprehensive analysis is to identify and form the TSSA 93 of language sentences 51, 52, 53 from the fourth data structure 5. For example, but not limited to, the formation of the TSSA 93 from the main BSSAs 92.1 and additional BSSAs 92. Y has at least the following requirements: if no additional BSSA 92. Y has been identified for the main BSSA 92.1, then the TSSA 93 is formed from only one element, which is the BSSA 92.1; if only one additional BSSA 92.Y has been identified for the main BSSA 92.1, then the TSSA 93 is formed from two elements, which are the main BSSA 92.1 and the BSSA 92. Y; if more than one additional BSSA 92.Y has been identified for the main BSSA 92.1, then for the formation of TSSA 93 it is necessary to set a unique name for the additional BSSA 92.Y, after which the TSSA 93 is formed from the main BSSA 92.1 and additional BSSAs 92. Y having unique names in accordance with the requirements of the formation of TSSA 93 based on the formalized model of the target construct of the subject area (FMTCSA). For example, but not limited to, the following sentences can be considered to demonstrate the formation of the TSSA 93:1) “The driver must drive the vehicle at a speed not exceeding the set limit, taking into account traffic intensity and the vehicle condition.”; 2) “Exceeding the allowed vehicle speed by more than 20 kmph, but not more than 40 kmph incurs imposition of an administrative fine in the amount of RUB 500.”.

In step 1010, the first sentence has been transformed into the following resulting judgements 91 (see Table 16):

TABLE 16

| | | | Simple judgement components 71 | | | | | | |
|---|---|---|---|---|---|---|---|---|---|
| | | | Subject | Predicate of a judgement (P) | | | | | |
| No. | No. | | of a | | | Subject of the | | | |
| RS | SP | SP | judgement | Action | Object | predicate | Complement | Additive | Manners |
| 91 | 81 | type | SPC1 | SPC2 | SPC3 | SPC4 | SPC5 | SPC6 | SPC7 |
| 1 | 2 | 3 | 4 | 5 | 6 | 7 | 8 | 9 | 10 |
| 1 | 1 | 81.1 | The driver | Must drive | The vehicle | — | — | at a speed | — |
| | 2 | 81.2 | a speed | not exceeding | the set limit | — | — | — | — |
| | 3 | 81.3 | The driver | taking into | traffic intensity | — | — | | At the |
| | | | | account | | | | | same |
| | | | | | | | | | time |
| 2 | 1 | 81.1 | The driver | Must drive | The vehicle | — | — | at a speed | — |
| | 2 | 81.2 | a speed | not exceeding | the set limit | — | — | — | — |
| | 3 | 81.5 | The driver | taking into | the vehicle | — | — | | At the |
| | | | | account | condition | | | | same |
| | | | | | | | | | time |

In step 1010, the second sentence has been transformed into the following resulting judgements 91 (see Table 17):

TABLE 17

| | | | Simple judgement components 71 | | | | | | |
|---|---|---|---|---|---|---|---|---|---|
| | | | | Predicate of a judgement (P) | | | | | |
| | | | Subject | | | Subject | | | |
| No. | No. | | of a | | | of the | | | |
| RS | SP | SP | judgement | Action | Object | predicate | Complement | Additive | Manners |
| 91 | 81 | type | SPC1 | SPC2 | SPC3 | SPC4 | SPC5 | SPC6 | SPC7 |
| 1 | 2 | 3 | 4 | 5 | 6 | 7 | 8 | 9 | 10 |
| 1 | 1 | 81.1 | exceeding the | incurs | imposition of an | — | — | — | — |
| | | | allowed vehicle | | administrative | | | | |
| | | | speed by more | | fine in the amount | | | | |
| | | | than 20 kmph | | of RUB 500 | | | | |
| 2 | 1 | 81.1 | exceeding the | incurs | imposition of an | — | — | — | — |
| | | | allowed vehicle | | administrative | | | | |
| | | | speed by no more | | fine in the amount | | | | |
| | | | than 40 kmph | | of RUB 500 | | | | |

In step 1011, the first sentence has been transformed into the following basic constructs of subject area 92, which are structural parts of legal norms in the law subject area (see Tables 18 and 19):

TABLE 18

| | | Components of the first part of the formal model | | | | | |
|---|---|---|---|---|---|---|---|
| | | of the structural part of the legal norm (BSSC 72) | | | | | |
| | | Legal rule | | | | | |
| | | Subjects of legal relations | | | | | |
| | | | A(ctive)/ | Object | Legal relations content | | |
| | No. | A(ctive) | P(assive) | of legal | Regulation | Modifying | |
| BSSA | SP | subject | subject | relations | method | objects | Definition |
| 92 No. | 81 | BSSC1 | BSSC2 | BSSC3 | BSSC4 | BSSC5 | BSSC6 |
| 1 | 2 | 3 | 4 | 5 | 6 | 7 | 8 |
| 1 | 1 | the driver [1] | — | the vehicle | must drive | at a speed | — |
| | 2 | — | — | A speed | not exceeding | the set limit | — |
| 2 | 1 | the driver [1] | — | the vehicle | must drive | at a speed | — |
| | 2 | — | — | A speed | not exceeding | the set limit | — |

TABLE 19

| | | Components of the second part of the formal model | | | | | | | |
|---|---|---|---|---|---|---|---|---|---|
| | | of the structural part of the legal norm (BSSC 72) | | | | | | | |
| | | Modifying legal facts | | | | | | | |
| | | | Modifying event (ME) | | | | | | |
| | | | | AE predicate | | | | | |
| | | Modifying | | AE | AE | AE | AE | AE | AE |
| SSA | No. | circumstance | AE entity | action | object | subject | complement | additive | manner |
| 92 | SP | BSSC7 | BSSC8 | BSSC9 | BSSC10 | BSSC11 | BSSC12 | BSSC13 | BSSC14 |
| No. | 81 | 9 | 10 | 11 | 12 | 13 | 14 | 15 | 16 |
| 1 | 1 | at the | [1] the | taking into | traffic | — | — | — | — |
| | | same time | driver | account | intensity | | | | |
| | 2 | — | — | — | — | — | — | — | — |
| 2 | 1 | at the | [1] the | taking into | the vehicle | — | — | — | — |
| | | same time | driver | account | condition | | | | |
| | 2 | — | — | — | — | — | — | — | — |

In step 1011, the second sentence has been transformed into the following BSSAs 92, which are structural parts of legal norms in the law subject area (see Tables 20 and 21):

TABLE 20

| | | Components of the first part of the formal model | | | | | |
|---|---|---|---|---|---|---|---|
| | | of the structural part of the legal norm (BSSC 72) | | | | | |
| | | Legal rule | | | | | |
| | | Subjects of legal relations | | | | | |
| | | | A(ctive)/ | Object | Legal relations content | | |
| SSA | No. | A(ctive) | P(assive) | of legal | Regulation | Modifying | |
| 92 | SP | subject | subject | relations | method | objects | Definition |
| No. | 81 | BSSC1 | BSSC2 | BSSC3 | BSSC4 | BSSC5 | BSSC6 |
| 1 | 2 | 3 | 4 | 5 | 6 | 7 | 8 |
| 1 | 1 | — | — | Exceeding the allowed | incurs | imposition of an | — |
| | | | | vehicle speed by more | | administrative | |
| | | | | than 20 kmph | | fine in the | |
| | | | | | | amount of RUB | |
| | | | | | | 500 | |
| 2 | 2 | — | — | Exceeding the allowed | incurs | imposition of an | — |
| | | | | vehicle speed by no more | | administrative | |
| | | | | than 40 kmph | | fine in the | |
| | | | | | | amount of RUB | |
| | | | | | | 500 | |

TABLE 21

| | | Components of the second part of the formal model | | | | | | | |
|---|---|---|---|---|---|---|---|---|---|
| | | of the structural part of the legal norm (BSSC 72) | | | | | | | |
| | | Modifying legal facts | | | | | | | |
| | | | Modifying event (ME) | | | | | | |
| | | | | AE predicate | | | | | |
| | | Modifying | AE | AE | AE | AE | AE | AE | AE |
| SSA | No. | circumstance | entity | action | object | subject | complement | additive | manner |
| 92 | SP | BSSC7 | BSSC8 | BSSC9 | BSSC10 | BSSC11 | BSSC12 | BSSC13 | BSSC14 |
| No. | 81 | 9 | 10 | 11 | 12 | 13 | 14 | 15 | 16 |
| 1 | 1 | — | — | — | — | — | — | — | — |
| 2 | 2 | — | — | — | — | — | — | — | — |

In step 1012, the first and second sentences have been transformed into the following TSSAs 93, which are legal norms in the law subject area, represented by, according to the formalized model of the target construct of subject area, two-element structures of a legal norm, made up of “dispositions” and “sanctions” (see Tables 22, 23, 24 and 25):

TABLE 22
LEGAL DISPOSITION

| | | Components of the first part of the formal model | | | | | |
|---|---|---|---|---|---|---|---|
| | | of the structural part of the legal norm (BSSC 72) | | | | | |
| | | Legal rule | | | | | |
| | | Subjects of legal relations | | | | | |
| | | | A(ctive)/ | Object | Legal relations content | | |
| | No. | A(ctive) | P(assive) | of legal | Regulation | Modifying | |
| TSSA | SP | subject | subject | relations | method | objects | Definition |
| 93 No. | 81 | BSSC1 | BSSC2 | BSSC3 | BSSC4 | BSSC5 | BSSC6 |
| 1 | 2 | 3 | 4 | 5 | 6 | 7 | 8 |
| 1 | 1 | the driver [1] | — | the vehicle | must drive | at a speed | — |
| | 2 | — | — | A speed | not exceeding | the set limit | — |
| 2 | 1 | the driver [1] | — | the vehicle | must drive | at a speed | — |
| | 2 | — | — | A speed | not exceeding | the set limit | — |

TABLE 23
LEGAL DISPOSITION

| | | Components of the second part of the formal model | | | | | | | |
|---|---|---|---|---|---|---|---|---|---|
| | | of the structural part of the legal norm (BSSC 72) | | | | | | | |
| | | Modifying legal facts | | | | | | | |
| | | | Modifying event (ME) | | | | | | |
| | | | | AE predicate | | | | | |
| | | Modifying | | AE | AE | AE | AE | AE | AE |
| | No. | circumstance | AE entity | action | object | subject | complement | additive | manner |
| TSSA | SP | BSSC7 | BSSC8 | BSSC9 | BSSC10 | BSSC11 | BSSC12 | BSSC13 | BSSC14 |
| 93 No. | 81 | 9 | 10 | 11 | 12 | 13 | 14 | 15 | 16 |
| 1 | 1 | at the | [1] the | taking into | traffic | — | — | — | — |
| | | same time | driver | account | intensity | | | | |
| | 2 | — | — | — | — | — | — | — | — |
| 2 | 1 | at the | [1] the | taking into | the vehicle | — | — | — | — |
| | | same time | driver | account | condition | | | | |
| | 2 | — | — | — | — | — | — | — | — |

TABLE 24
LEGAL SANCTION

| | | Components of the first part of the formal model | | | | | |
|---|---|---|---|---|---|---|---|
| | | of the structural part of the legal norm (BSSC 72) | | | | | |
| | | Legal rule | | | | | |
| | | Subjects of legal relations | | | | | |
| | | | A(ctive)/ | Object | Legal relations content | | |
| | | A(ctive) | P(assive) | of legal | Regulation | Modifying | |
| | No. | subject | subject | relations | method | objects | Definition |
| TSSA | SP | BSSC1 | BSSC2 | BSSC3 | BSSC4 | BSSC5 | BSSC6 |
| 93 No. | 81 | 17 | 18 | 19 | 20 | 21 | 22 |
| 1 | 1 | — | — | Exceeding the | incurs | imposition of an | — |
| | | | | allowed vehicle | | administrative | |
| | | | | speed by more | | fine in the | |
| | | | | than 20 kmph | | amount of RUB | |
| | | | | | | 500 | |
| 2 | 2 | — | — | Exceeding the | incurs | imposition of an | — |
| | | | | allowed vehicle | | administrative | |
| | | | | speed by no more | | fine in the | |
| | | | | than 40 kmph | | amount of RUB | |
| | | | | | | 500 | |

TABLE 25
LEGAL SANCTION

| | | Components of the second part of the formal model | | | | | | | |
|---|---|---|---|---|---|---|---|---|---|
| | | of the structural part of the legal norm (BSSC 72) | | | | | | | |
| | | Modifying legal facts | | | | | | | |
| | | | Modifying event (ME) | | | | | | |
| | | | | AE predicate | | | | | |
| | | Modifying | AE | AE | AE | AE | AE | AE | AE |
| | No. | circumstance | entity | action | object | subject | complement | additive | manner |
| TSSA | SP | BSSC7 | BSSC8 | BSSC9 | BSSC10 | BSSC11 | BSSC12 | BSSC13 | BSSC14 |
| 93 No. | 81 | 23 | 24 | 25 | 26 | 27 | 28 | 29 | 30 |
| 1 | 1 | — | — | — | — | — | — | — | — |
| 2 | 2 | — | — | — | — | — | — | — | — |

The TSSAs 93 of the final data structure 12 can be identified and generated in any way known from prior art that, accordingly, are not described any further. For example, but not limited to, such identification and generation can be performed either traditionally, by a law specialist, or through a traditional programming approach based on encoded immutable rules (a rule-based system) using a software algorithm of a language (syntactic) processor. In addition, given enough samples, such analysis can be performed using a statistical processor (neural networks, AI systems) using neural network/AI training technologies.

Preferably, but not limited to, the final data structure 12 is generated in step 10122 by combining the elements 93 (TSSAs 93) of the final data structure 12 and their identification data in a single data structure using methods and principles known from prior art and, accordingly, not described any further.

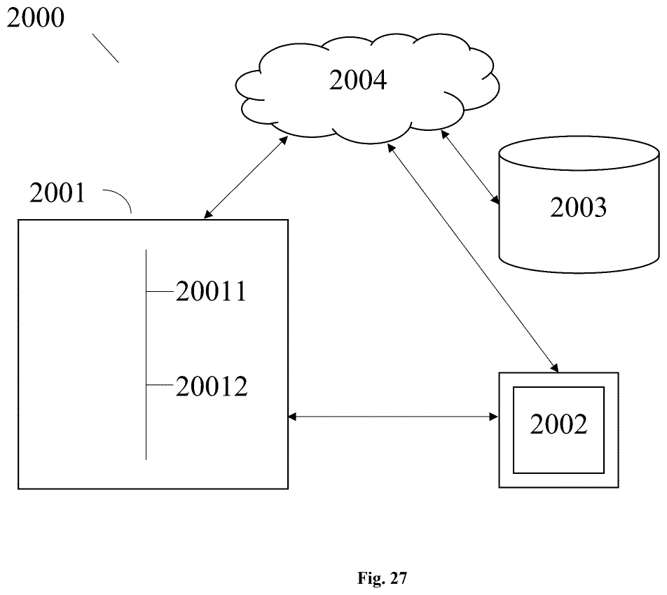

FIG. 27 illustrates an exemplary, non-limiting, overall scheme for the system 2000 for transforming a structured data array, the system, in its preferred embodiment, comprising at least one or more computer devices 2001 for transforming a structured data array, which comprises at least one or more CPUs 20011 and a memory unit 20012. Said computer devices 2001 for transforming a structured data array may include, but not limited to: a PC, a laptop, a tablet, a pocket computer, a smartphone, a phablet, etc. The memory (machine-readable storage device) 20012 of the device 2001 for transforming a structured data array stores the program code that, when executed, induces the one or more CPUs 20011 of the device 2001 to perform the steps according to the methods for transforming a structured data array disclosed herein. In some cases, the computer device 2001 may be a server computer device connected to a user computer device, which is configured to send instructions to the server computer device 2001 that induce the one or more CPUs 20011 of the server computer device to execute the program code that, when executed by the one or more CPUs 20011 of the server computer device, induce the one or more CPUs 20011 of the server computer device to perform the steps of any of the methods for transforming a structured data array disclosed herein. A user computer device 2002 can be, but not limited to: a PC, a laptop, a tablet, a pocket computer, a smartphone, a phablet, a thin client, etc. The user computer device 2002 can be connected to the server computer device 2001 via a wired or wireless connection. Said memory 20012 of the computer device 2001 (server computer device 2001) stores one or more structured data arrays to be converted, which contain at least a linguistic sentence, and may also store any of the data structures described above for any of the methods for transforming a structured data array disclosed herein. In addition, one or more structured data arrays to be converted, user databases, other databases, models and data tables, and other data as well can be loaded and stored, in particular, in the database 2003 of the system for transforming a structured data array. For example, but not limited to, the computer-readable medium (memory 20012) may comprise a random-access memory (RAM); a read-only memory (ROM); an electrically erasable programmable read-only memory (EEPROM); a flash drive or other memory technologies; a CD-ROM, a digital versatile disk (DVD) or other optical/holographic media; magnetic tapes, magnetic film, a hard disk drive or any other wave-carrying magnetic drive; and any other storage medium capable of storing the necessary information, which can be accessed through the device 2001 for transforming a structured data array. Memory comprises a computer-readable medium based on the computer memory, either volatile or non-volatile, or a combination thereof. Exemplary hardware devices include solid-state drives, hard disk drives, optical disk drives, etc. The memory stores an exemplary environment, in which the procedure for transforming a structured data array can be performed using computer instructions or codes stored on the device. The device comprises one or more CPUs 20011 designed to execute computer instructions or codes that are stored in the device's memory, in order to perform the procedure for transforming a structured data array. Computer instructions or codes that are stored in the device's memory are designed to convert a structured data array. The 2000 system may also comprise a database 2003. The database 2003 may be, but not limited to, a hierarchical database, a network database, a relational database, an object database, an object-oriented database, an object-relational database, a spatial database, a combination of two or more said databases, etc. The database 2003 data are stored in the memory that may include, but not limited to: a read-only memory (ROM); an electrically erasable programmable read-only memory (EEPROM); a flash drive; a CD-ROM, a digital versatile disk (DVD) or other optical/holographic media; magnetic tapes, magnetic film, a hard disk drive or any other wave-carrying magnetic drive; and any other storage medium capable of storing the necessary information, which can be accessed through the device 2001 for transforming a structured data array. The database 2003 is used to store data, which include at least commands for executing the steps of the methods for transforming a structured data array as described above, as well as one or more structured data arrays to be converted, which contain at least a language sentence or one of the initial data structures that can be used for any of the transforming methods described above, which can be stored in the memory 20012 of the device 2001 for transforming a structured data array, and other data that may be necessary for the system to function. The exemplary system 2000 for transforming a structured data array may further comprise a server computer device 2001, which, in addition to the functions described above, is also capable of storing and assisting in manipulations computer instructions or codes that are described above and, therefore, are not described any further. In addition to the functions listed above, the server computer device 2001 may regulate data exchange in the system 2000 for transforming a structured data array, as well as process data, provided one or more user computer devices 2002 are connected to it. In this case, all the computing power required to execute the procedure for transforming a structured data array is located on the server computer device 2001. The system 2000 may also comprise one or more data exchange networks 2004. Data exchange networks 2004 may include, but not limited to, one or more local area networks (LAN) and/or wide area networks (WAN), or may be represented by the Internet or Intranet, or a virtual private network (VPN), or a combination thereof, etc. The server computer device 2001 is also capable of providing a virtual computing environment (Virtual Machine) to enable interaction between the user computer device 2002 and the database 2003. The data exchange network 2004 is designed to enable interaction between the computer device 2001, the database 2003 and the user device 2002 of the system 2000 for transforming a structured data array. In addition, the user computer device 2002 can be directly connected to the server computer device 2001 using wired and wireless communication methods known from prior art that, accordingly, are not described any further. For example, but not limited to, said devices 2001 and 2002 may be equipped with input/output (IO) devices that are capable of presenting to the user the results of any of the steps of any of the proposed methods disclosed above with reference to FIGS. 1-26.

The present disclosure of the claimed invention demonstrates only certain exemplary embodiments of the invention, which by no means limit the scope of the claimed invention, meaning that it may be embodied in alternative forms that do not go beyond the scope of the present disclosure and which may be obvious to persons having ordinary skill in the art.

1. A computer device for transforming a structured data array, the array comprising at least information objects in a digitalized document, which are separate blocks of information content of the digitalized document, represented by text information objects, and/or visual information objects, and/or text-visual information objects; the device comprising at least:
a CPU;
a memory which contains a program code, which, when executed by at least one CPU of a computer device induces the computer device to perform a method for transforming a structured data array, the array comprising at least information objects in a digitalized document, which are separate blocks of information content of the digitalized document, represented by text information objects, and/or visual information objects, and/or text-visual information objects; the method comprising:
generating at step 1001 a first data structure comprising meaning components of the information objects in the digitalized document, as well as comprising identification data of said meaning components, which comprises meanings of the meaning components and their index numbers in the digitalized document;
generating at step 1002 a database of system features of the meaning components by identifying system features in the first data structure of meaning components, namely their formatting system characteristics and functional system characteristics, as well as meanings of corresponding system characteristics, in order to identify meaning components with structural system features, and/or meaning components with logical system features, and/or meaning components with information system features, and/or meaning components with meta system features, and generating the database from the identified system features;
generating at step 1003 a second data structure comprising integrated meaning components of information objects in the digitalized document, which are either grouped meaning components from the first data structure with matching system features or grouped meaning components from the first data structure with unique system features, as well as comprising identification data of said integrated meaning components, represented by non-repeating varieties of said meaning components with either matching system features or unique system features, and meanings of said meaning components with either matching system features or unique system features, and their index numbers in the digitalized document, wherein such meaning components with either matching system features or unique system features form said integrated meaning components;
generating at step 1004 a third data structure comprising linguistic constructs, which are said integrated meaning components of information objects in the digitalized document contained in the second data structure, wherein said integrated meaning components have system features of text-logical meaning components, as well as comprising identification data of said linguistic constructs, which comprises meanings of said linguistic constructs and their index numbers in the digitalized document, wherein said linguistic constructs in the digitalized document can be represented by:
either regular linguistic constructs from the third data structure, which are language sentences,
or special linguistic constructs from the third data structure, which are lists or rolls, or reconstructible linguistic constructs from the third data structure, which are tables comprised of at least two rows and two columns, wherein at least one row contains column headings and/or at least one column contains row headings respectively, or a combination thereof;
generating at step 1005 a fourth data structure comprising language sentences generated from elements of the third data structure and represented by:
either regular linguistic constructs from the third data structure,
or language sentences obtained by transforming special linguistic constructs from the third data structure,
or language sentences recreated from reconstructible linguistic constructs from the third data structure,
wherein the fourth data structure as well as comprises identification data of said language sentences, which comprises meanings of said language sentences and their index numbers in the fourth data structure;
generating at step 1006 a fifth data structure comprising text elements of said language sentences from the fourth data structure, as well as comprising identification data of said text elements, which comprises meanings of said text elements and their index numbers in corresponding language sentences from the fourth data structure;
generating at step 1007 a database of linguistic-logical-subject features by identifying linguistic-logical-subject features of said text elements of said language sentences from the fourth data structure, and generating a database from said identified features;
generating at step 1008 a sixth data structure comprising simple judgement components, which are contained in corresponding language sentences from the fourth data structure, as well as comprising identification data of said simple judgement components, which comprises a type of a component, its meaning, and its index number in corresponding language sentence;
generating at step 1009 a seventh data structure comprising simple judgements from corresponding language sentences from the fourth data structure, as well as comprising identification data of said simple judgements, which comprises meanings of said simple judgements and their index numbers in corresponding language sentences from the fourth data structure;
generating at step 1010 an eighth data structure comprising resulting judgements from corresponding language sentences from the fourth data structure which are generated from said simple judgements from corresponding language sentences from the fourth data structure, as well as comprising identification data of said resulting judgements, which comprises meanings of said resulting judgements and their index numbers in the eighth data structure;
generating at step 1011 a ninth data structure comprising basic constructs of subject area which are generated from data that include the data from the sixth data structure generated in step 1008, wherein said basic constructs of subject area are generated based on data of a formalized model of the basic construct of subject area and data of a formalized model of the logical construct of a judgement, as well as comprising identification data of said basic constructs of subject area, which comprises meanings of said basic constructs and their index numbers in the ninth data structure; and
generating at step 1012 a final data structure comprising target constructs of subject area which are generated from said basic constructs of subject area contained in the ninth data structure, wherein said target constructs are generated based on the data of a formalized model of the target construct of subject area, as well as comprising identification data of said target constructs of subject area, which comprises meanings of the target constructs and their index numbers in the final data structure.

2. The device of claim 1, characterized in that step 1003 further comprises:
identifying and generating at step 10031 elements of the second data structure, represented by integrated meaning components of information objects in the digitalized document, which are either grouped meaning components from the first data structure with matching system features or grouped meaning components from the first data structure with unique system features, as well as comprising identification data of said integrated meaning components, represented by non-repeating varieties of said meaning components with either matching system features or unique system features, meanings of said meaning components with either matching system features or unique system features, and their index numbers in the digitalized document, wherein such meaning components with either matching system features or unique system features form said integrated meaning components; and
generating at step 10032 the second data structure from the identified and generated elements of the second data structure, and their identification data.

3. The device of claim 1, characterized in that step 1004 further comprises:
identifying and generating at step 10041 elements of the third data structure, represented by linguistic constructs, which are said integrated meaning components of information objects in the digitalized document contained in the second data structure, wherein said integrated meaning components have system features of text-logical meaning components, as well as comprising identification data of said linguistic constructs, which comprises meanings of the linguistic constructs and their index numbers in the digitalized document, wherein the linguistic constructs in the digitalized document are represented by:
either regular linguistic constructs from the third data structure, which are language sentences, or
special linguistic constructs from the third data structure, which are lists or rolls, or reconstructible linguistic constructs from the third data structure, which are tables comprised of at least two rows and two columns, wherein at least one row contains column headings and/or at least one column contains row headings respectively, or a combination thereof; and
generating at step 10042 the third data structure from the elements of the third data structure, identified and generated at step 10041, and their identification data.

4. The device of claim 1, characterized in that step 1005 further comprises:
identifying and generating at step 10051 a first elements of the fourth data structure, as well as their identification data, which comprises meanings of each of the first elements of the fourth data structure and their index numbers in the fourth data structure, wherein said first elements are represented by language sentences generated from elements of the third data structure, which comprises regular linguistic constructs, by matching said language sentences from the fourth data structure with the regular linguistic constructs from the third data structure;
identifying and generating at step 10052 a second elements of the fourth data structure, as well as their identification data, which comprises meanings of each of the second elements of the fourth data structure and their index numbers in the fourth data structure, wherein said second elements are represented by language sentences generated from the elements of the third data structure, which comprises special linguistic constructs, by transforming the special linguistic constructs into said language sentences from the fourth data structure;
identifying and generating at step 10053 a third elements of the fourth data structure, as well as their identification data, which comprises meanings of each of the third elements of the fourth data structure and their index numbers in the fourth data structure, wherein said third elements are represented by language sentences generated from the elements of the third data structure, which comprises reconstructible linguistic constructs, by using the data contained therein to recreate separate language sentences from the fourth data structure; and
generating at step 10054 the fourth data structure from the first elements, the second elements, and the third elements of the fourth data structure, and their identification data.

5. The device of claim 1, characterized in that step 1007 further comprises:
generating at step 10071 a first portion of linguistic-logical-subject features of said text elements of said language sentences from the fourth data structure, wherein the identification data of said text elements from the fifth data structure, classified as words, are presented for linguistic analysis to obtain linguistic parameters of said text elements, as well as meanings of said linguistic parameters;
generating at step 10072 a second portion of linguistic-logical-subject features of said text elements of said language sentences from the fourth data structure, wherein the identification data of said text elements from the fifth data structure, classified as words, together with their linguistic parameters and meanings thereof, are presented for logical analysis to obtain logical parameters of said text elements in each language sentence, as well as meanings of said logical parameters;
generating at step 10073 a third portion of linguistic-logical-subject features of said text elements of said language sentences from the fourth data structure, wherein the identification data of said text elements from the fifth data structure, classified as words, together with their linguistic parameters and meanings thereof, as well as their logical parameters and meanings thereof, are presented for subject analysis to obtain subject parameters of said text elements in the subject area, as well as meanings of said subject parameters;
generating at step 10074 the database of linguistic-logical-subject features of said text elements of said language sentences from the fourth data structure, wherein said linguistic-logical-subject features are represented by the linguistic parameters, the logical parameters, and the subject parameters and meanings thereof, which were obtained for each text element in steps 10071, 10072, and 10073.

6. The device of claim 1, characterized in that step 1008 further comprises:
generating at step 10081 elements of the sixth data structure, which are components of simple judgements of corresponding language sentences from the fourth data structure, as well as their identification data, which comprises a type of each component, its meaning, and its index number in corresponding language sentence from the fourth data structure, wherein said elements are identified and generated based on contents of the database of linguistic-logical-subject features, the fifth data structure, and a first user database that contains data of relevant syntactical units, relevant logical objects, and relevant formalized model of the logical structure of a judgment; and
generating at step 10082 the sixth data structure from said components of simple judgements, and their identification data.

7. The device of claim 1, characterized in that step 1009 further comprises:
generating at step 10091, from said components of simple judgements generated according to an actual formalized model of the logical structure of a judgment, elements of the seventh data structure, which are simple judgements, as well as their identification data, which comprises meanings of corresponding simple judgements and their index numbers in corresponding language sentences from the fourth data structure, based on data of the database of linguistic-logical-subject features, and the sixth data structure; and
generating at step 10092 the seventh data structure from said simple judgements, and their identification data.

8. The device of claim 1, characterized in that step 1010 further comprises:
generating at step 10101 elements of the eighth data structure, which are resulting judgements of corresponding language sentences from the fourth data structure, as well as their identification data, which comprises meanings of said resulting judgements and their index numbers in the eighth data structure, wherein said elements are identified and generated based on data of the database of linguistic-logical-subject features, and the seventh data structure, as well as according to an actual formalized model of the logical structure of a judgement; and
generating at step 10102 the eighth data structure from said resulting judgements, and their identification data.

9. The device of claim 1, characterized in that step 1011 further comprises:
generating at step 10111 elements of the ninth data structure, which are basic constructs of subject area, as well as their identification data, which comprises meanings of said basic constructs and their index numbers in the ninth data structure, wherein said elements are identified and generated based on data of the database of linguistic-logical-subject features, a second user database, and the sixth data structure as well as according to an actual formalized model of the basic construct of subject area and an actual formalized model of the logical structure of a judgement; and
generating at step 10112 the ninth data structure from said basic constructs of subject area, and their identification data.

10. The device of claim 1, characterized in that step 1012 further comprises:
generating at step 10121 elements of the final data structure, which are target constructs of subject area, as well as their identification data, which comprises meanings of said target constructs and their index numbers in the final data structure, wherein said elements are identified and generated based on data of a third user database and the ninth data structure, as well as according to an actual formalized model of the target construct of subject area; and
generating at step 10122 the final data structure from said target constructs of subject area, and their identification data.
